(19) United States
(12) Patent Application Publication
(10) Pub. No.: US 2015/0279156 A1
(43) Pub. Date: Oct. 1, 2015

(54) TICKETING DATA ENTRY

(71) Applicant: OMARCO NETWORK SOLUTIONS LIMITED, Isle of Man, British Isles (GB)

(72) Inventor: Ralph Mahmoud Omar, Douglas (IM)

(21) Appl. No.: 14/428,592

(22) PCT Filed: Sep. 18, 2013
(86) PCT No.: PCT/IB2013/058643

§ 371 Date: Mar. 16, 2015

(30) Foreign Application Priority Data
Sep. 18, 2012 (GB) 1216634.4
Dec. 14, 2012 (GB) 1222773.2
Feb. 18, 2013 (GB) 1302812.1
Mar. 1, 2013 (GB) 1303726.2

(51) Int. Cl. G07F 17/32; G06Q 20/10; G06Q 50/34

(52) U.S. Cl. CPC G07F 17/3241; G06Q 50/34; G06Q 20/1085; G07F 17/329; G07F 17/3225; G07F 17/3211

(57) ABSTRACT

A high-security gaming system for implementing a real-time instant-win game is described. The system comprises: a game card arranged to facilitate game card player interaction to play the real-time instant-win game, the game card includes: a unique game card identifier; a two-dimensional scene which has a missing object; and location means for accurately specifying a player-selected location of the missing object within the scene; a terminal arranged to receive game card information relating to the unique game card identifier and the player-selected location specified by the location means; and an authentication server, operably coupled to the terminal by a communications network, for authenticating the game card and determining the result of the instant-win game; wherein the terminal is arranged to communicate the game card information to the authentication server via the telecommunications network and the authentication server is arranged to receive and use the game card information to: authenticate the validity of the game card by use of an authentication process on the received game card identifier; carry out a comparison of the player-selected location with a predetermined correct location of the missing object for that game card; and send a win message to the terminal to indicate an instant win if the player selected location is within a predetermined distance of the correct location of the missing object.

### FIELD OF THE INVENTION

The present invention is directed to several different aspects of improvements relating to ticketing data entry and also gaming ticket authentication.

### BACKGROUND OF THE INVENTION

Various formats for ticketing are known for playing a game. When the gaming is related to a prize draw or a lottery, the gaming is related to an event which will take place in the future at a known time (future-event gaming). Ticketing for such future-event gaming is simple and cheap as the functionality of the tickets required for this activity is relatively simple. When gaming is related to an event which occurs in real-time, the gaming is often described as ‘instant-win’ gaming as the player can determine at that time whether they have won a prize and be presented with the prize at that time. For some instant-win gaming, dedicated gaming machines are used, which is typically very expensive. Alternatively, ticketing for instant-win type gaming is typically complex because of the need for greater security in the ticket itself and also typically expensive due to the need for some form of player-interaction equipment for interaction with the player to determine whether the player has won a prize. One other form of ticketing-only instant-win type gaming is known; namely an instant-win scratch card.

A scratch card (described below) is a known instant-win construct which has been very successful in the past and has led to it being mass-producible (scalable) and having widespread use throughout the world. This is due to its ability to provide an instant win with a reasonable level of security and a relatively low cost (without the requirement for expensive gaming equipment). Also the selling and prize handling of such scratch-cards is relatively simple for retailers. A scratch card is an instant-win gaming device (ticket) where the card is provided with a selection of areas with objects on them which are covered from the player's view by a scratch-off coating. When a player purchases the scratch card, they can see that the card has been unused if the scratch-off covering is intact.

In use, the player can scratch-off part of the coating to reveal a selection of the possible areas and hence a selection of the objects. If the selection matches a predetermined winning selection then the player wins instantly and can present their ticket to the retailer for redemption of their prize. The retailer simply confirms that the selection of objects which have been revealed correspond to a predetermined winning selection and also checks to see if the rest of the scratch-off coating is intact. If these checks are passed the retailer gives the player the predetermined prize associated with the predetermined winning selection of objects.

Normally, the objects provided underneath the scratch-off coating vary from card to card such that it is not possible to use a winning card to deduce any information about another winning card. Also it is required that for a winning entry the scratch-off coating is intact and not scratched off in all other areas apart from the winning areas. These features provide security in the scratch card. However, the scratch-off coating prone to damage for example when it is being handed in the distribution chain prior to sale or at the point of sale (POS). When a winning card is redeemed, there can often be problems because of portions of the scratch card which have been damaged (partially removed). It is not possible to determine whether such damage was caused during the distribution chain or as a result of the purchaser trying to fraudulently scratch off more than one location. Accordingly, even when a genuine scratch card has a portion of the scratch-off coating missing, this card is considered void. This leads to an undesirably-high error rate in potential gaming entries.

One other problem with known scratch cards is that they have a value in the supply chain and that if they are stolen prior to sale they can still be used as a chance of winning. Also, the vendor or the main issuer of the card may not be able to tell the difference between a genuine card that has been correctly sold and one which has been deliberately tampered with to effect fraud. Examples of such tampering include submitting a scratch card that is genuine, but that has nonetheless been purloined from either the establishment of the vendor or from another vendor. In addition, the main issuer may be open to vendor fraud such that card is scratched until it shows a winning position and the vendor then reports any card he has scratched that doesn't show a winning position, as stolen and not paid for.

All of the security in such scratch cards relies solely on the inability for a fraudster to be unable to look under the scratch-off coating to see the objects underneath. If the fraudster can purchase a card and determine what lies beneath the scratch-off coating then they can overcome the security of the scratch card. Also if the fraudster is able to remove the scratch-off coating, determine the locations of the winning objects, reapply the coating themselves, and then scratch off the known winning locations, they also overcome the security of the scratch card.

Clearly, the traditional scratch-card ticketing is low cost as there is no need for any ticketing machine. However, this comes at the expense of security which is reliant on the scratch-off coating being secure and intact and which results in high void card rates.

There has also been a move towards online gaming which is also termed ‘instant-win gaming’. This form of gaming is based on online games being provided at a website to which the player has to connect. Also the player typically has to have an account with the website operator to pay for the gaming and to receive his or her winnings which are merely credited to the account. However, not only does such gaming require the player to have a device with a browser to visit the gaming website, but also an internet connection is required throughout the gaming session. This not only adds to the complexity of the gaming but also restricts its use based on the availability of such an internet connection. Another problem is that the gaming cannot be anonymous as the player has to register with the website providing his or her own identification details. Finally the win, although being claimed to be instant, does not result in an instant-win prize being given in real time to the player. Rather, the player's online account is merely updated with the win value should the player win the online game and the player has to perform some subsequent action to actually receive the prize. Whilst the security is improved, this is not true instant-win gaming and does not provide a simple, scalable solution to the problems described above.

It is desired to overcome these problems of security and cost associated with traditional techniques for providing apparatus (ticketing) for implementing ‘instant-win’ gaming.

### SUMMARY OF THE INVENTION

One aspect of the present invention resides in the appreciation that a combination of simple ticketing and simple apparatus for implementing the ticketing provides the optimum solution to the above described problems of cost and security with existing apparatus for instant-win ticketing described above. In order to address the potential issues with instant-win scratch cards, the present invention uses a game card with a two-dimensional scene provided on it. The scene is subdivided into a plurality of sub-regions with each sub-region being uniquely identifiable. In use, the player selects a sub-region within the scene and marks this on the game card. The mark is the player's best attempt to determine the location of a missing object from the scene and, in one embodiment this aspect is similar to a previously known future-event ‘spot-the-ball’ game (described in detail below). However, unlike the previously known spot-the-ball’ game, the relative positioning of the selected sub-region provides an entry into an instant-win game. The game card is then scanned by a simple terminal scanner to read the player-selected entry and a machine-readable unique identifier of the game card. This information is transmitted to a central authentication server where the position of the player-selected sub-region is compared to a known correct position of the missing object from the scene. The player wins an instant prize if the selected sub-region matches the known correct position or is within a predetermined distance of the correct position. The server then notifies the terminal and the retailer can then give the prize to the player for redemption of the winning game card.

The present invention advantageously overcomes at least some of the problems associated with the prior art. In particular, the game card has no value in the distribution chain and as each card has a unique identifier on it, this enables the game cards to be activated shortly prior to sale and only be valid for a specific terminal. This greatly reduces the opportunity for fraud. Also by not relying on a scratch-off coating for security, most of the above-described disadvantages of poor security and high rates of spoilt/unusable cards due to damage in the distribution chain are mitigated. The security in the present invention comes from a combination of requiring the entry to be validated by a central server and for the entry to be linked to a specific card by transmission of the unique identifier of the game card. The transmission of the unique card identifier can also be logged at the central server such that if that unique identifier is presented again, the central server will know this is fraudulent.

The instant-win aspect in its correct form is maintained by a communication back to the terminal by the central authentication server indicating a winning game card to the terminal, which enables the terminal or in the case of a manned terminal the operator (e.g. retailer) to dispense a prize for redemption of a winning game card. Whilst a terminal is required, the functionality of the terminal is very simple, namely to scan in the game card, transmit the instant-win entry to the central authentication server, and receive a notification of a winning entry. In this aspect, the terminal can be low-cost and similar to that of a lottery terminal. The terminal can alternatively be an existing terminal (such as an ATM (Automated Teller Machine)) which has been modified (retrofitted) with the ability to carry out the required terminal functionality. The communication to the central authentication server can simply be via a low-cost telephone line or even a mobile telephone network such as GPRS rather than requiring an internet connection.

This activation of the game card by the terminal can also refer to activation via the player's own mobile device wherein the game card that has been marked by the player is then scanned (image captured) by the player's own mobile device and (if required to have payment other than at the manned terminal or unmanned terminal such as an ATM) then the payment can be subtracted from the player's mobile device account (pre-paid or post-pay) according to a conventional mobile phone transaction process.

More specifically, according to one aspect of the present invention there is provided a high-security gaming system for implementing a real-time instant-win game, the system comprising: a game card arranged to facilitate game card player interaction to play the real-time instant-win game, the game card including: a unique game card identifier; a two-dimensional scene which has a missing object; and location means for accurately specifying a player-selected location of the missing object within the scene; a terminal arranged to receive game card information relating to the unique game card identifier and the player-selected location specified by the location means; and an authentication server, operably coupled to the terminal by a communications network, for authenticating the game card and determining the result of the instant-win game; wherein the terminal is arranged to communicate the game card information to the authentication server via the telecommunications network and the authentication server is arranged to receive and use the game card information to: authenticate the validity of the game card by use of an authentication process on the received game card identifier; carry out a comparison of the player-selected location with a predetermined correct location of the missing object for that game card; and send a message to the terminal to indicate an instant win if the player selected location is within a predetermined distance of the correct location of the missing object.

The present invention, in at least one of its embodiments, advantageously provides an on-demand instant-win game card that is nonetheless secure and can be printed in a large number of locations by simple low-cost printing methods, such as by colour or black-and-white printing on thermographic or non-complex paper or other substrates, and which is able to support the reading of player-selected gaming information such as that required by a spot-the-ball game. One significant problem that is addressed is the prevention of any common abnormalities in the printing process from disrupting the function of the card in practice. For example, the printing process may create false dots that would be picked up by a scanner and would create problems in determining how the player had actually marked the card to indicate their selection. This problem is particularly compounded when the card is functioning as a spot-the-ball game card where the player will mark with a dot a location in a picture indicating location of a ball of similar object which has to be read by a scanner.

‘Spot-the-ball’ is a known ‘future-event’ type of game played traditionally using pictures of a sporting scene with the ball or movable object (such as a puck) being removed prior to the picture being provided to potential players. The object of the game is for the player to guess where the hidden ball is in the scene using their skill and judgement. Many different players all submit their paper entries to a central authority and, at some future point in time, the authority declares a winner as the player who has successfully placed a mark closest to the winning marked position (which is known only to the issuer or is effectively concealed).

This type of future-event gaming has never been provided as an instant-win construct due to the fact that if one ticket was shown to have uncovered the correct location of the ball, resulting in an instant win, then a subsequent ticket could be purchased and the same position chosen to result in a further instant win. This would lead the game open to fraud. Another problem which has prevented the spot-the-ball type of game from being provided in an instant-win construct, is that it is also possible for fraudsters to replicate the spot-the-ball scene of a genuine card multiple times to create multiple base cards, and thereafter place a scratch-off coating on each card. Each of these cards could then potentially provide a fraudulent entry into the spot-the-ball game enabling multiple entries into the instant-win spot-the-ball game without payment.

The present invention enables the spot-the-ball type of game to be realised in an instant-win format. This is because the game card is merely used to facilitate the player's entry into the game; the security of the game being provided by the authentication carried out by the central server to determine if it is a winning card.

According to another broad aspect of the present invention there is provided A high-security game card arranged to facilitate game card player interaction to play a real-time instant-win game, the game card comprising: a unique game card identifier; a two-dimensional scene which has a missing object; and location means for accurately specifying a player-selected location of the missing object within the scene.

The game card can be embodied in either a scratch card form or a non-scratch card form. When the card is provided as a scratch card, the scene is printed on top of the scratch off coating such that the player simply scratches off a sub-region in the scene where they believe the ball to be. Under the scratch-off coating each sub-region has a unique machine-readable identifier, for example a code or mark, which is revealed by the scratch-off operation. Damage to other parts of the scratch-off coating presenting the two-dimensional scene may not invalidate the scratch card as the tolerance for such defects is greater. This is because so long as no other unique reference of a sub-region is revealed, the card can still function correctly. Preferably, the machine-readable sub-region references change for every card such that two identical sub-regions for the same scene will have different sub-region references.

If the game card does not have a scratch-off coating, then the scene is printed on the game card and the player simply has to mark the location of the missing ball within the scene. However, this can present a problem when marking a pre-printed card with a player-selected location (as opposed to scratching off a single location from a scratch-off coating). More specifically, if the location to be marked is within a white space (defined later) there is no problem due to their being sufficient contrast between the mark and the background for machine recognition. However, if the mark is within the blocked space (defined later), then there is a risk that the mark will not be picked up by the electronic image scanner due to the potential for the contrast difference between the background image and the mark to not be great enough for the scanner to detect the mark. In order to overcome this potential problem, two of the adjacent and perpendicular edges of the scene are provided with graduated axes such that for any location where a mark is made, the corresponding coordinate position on the graduated axes can be marked. The graduated axes are provided on a white background as they are not part of the scene and they do not suffer from the low contrast problem described above. This additional marking overcomes the contrast problems of relying solely on a mark within the scene.

This problem is overcome in virtual game cards by the use of player-manipulable crosshairs which can be manipulated from the regions outside the blocked area thereby overcoming the problem.

It is possible in some embodiments to implement the game card electronically on a player's mobile device. Unlike the prior art where instant-win prizes have not been possible, these are now available because of the ability to provide the player with an immediate win which can be collected at a terminal. Also where user terminals are not available a credit can immediately be provided to the player's mobile device account.

One non-limiting aspect of the present invention resides in a process of issuing a game card having a scratch-off portion thereon, wherein in the scratch-off portion is scanned on activation of the card to determine any abnormalities thereon, to authenticate the unused card if it is determined to be sufficiently free from abnormalities, to generate a unique authentication identifier and to print the same on the card. If there are severe abnormalities, the card is rejected, however a far greater tolerance is provided by this technique as the scratch-off coating is only being used to select a grid location for the missing object rather than providing the security itself. This technique enables a better delineation than in the prior art between defects to a scratch-off surface due to distribution handling (now more acceptable), and defects caused by the player, after sale, trying to defraud the gaming authority or other issuing body (not acceptable).

Another non-limiting aspect of the present invention also resides in the appreciation that the problem of having a player mark provided in a blocked region, can be overcome by using a cross-hairs technique in which cross-hair lines extending from the selected point are drawn by the player until at least two of those lines extend into white space. A scanner will be able to detect at least these extended cross-hair lines in white space and can extrapolate the lines to find either the exact location or “the best fit” for the location of the intersection or at least eliminate other markings not occurring at or close to the extrapolated intersection. The scanner can “follow” two lines with irregularities that may occur with hand drawing to “see” where they actually cross and the algorithms that distinguish “white space” outside the two lines can be used which rely on a greater or lesser than value would be considerably different to manufacturing errors etc. which will have a lesser plus or minus variable. In this embodiment the player could draw lines of a minimum length to the centre that he/she believes the ball to be in to create a differentiation value relative to the statistical damage that could occur during manufacturing. This value can be established so that the player can be given clear instructions on how long the minimum line should be e.g. 2 cm, 3 cm or 4 cm etc.

More specifically, according to another aspect of the present invention there is provided A method of recording a missing object location within a scene of a virtual gaming card, the method comprising: displaying the scene having a blocked region and a white-space region on the display of a device; providing two player-manipulable crosshairs located transversely to each other, which can be extended into the white-space region of the scene; enabling adjustment of the positions of the crosshairs on the scene to define the missing object location at the crossing point of the crosshairs; and recording the missing object location.

The current aspect of the present invention also enables a spot-the-ball type competition to be adapted to become an instant-win gaming construct. In this regard, there are sometime issues with the scanner detecting the player marking from printing errors and other marks in the scene as has been described above. Another way of addressing this problem is for the player to place a dot designating the exact centre of the selected location and draw a circle within a notified distance range of the dot designating the exact centre. The player can then draw a line from the circumference of the circle to the dot designating the exact centre (similar to that of the radii of the circle). The player can also choose to draw a circle/or square/or other shape corresponding to the outline of the object at a slightly larger size than the object itself and then a line from this border of the circle/or square/or shape corresponding to the outline of the object and in this case the instant prize will be whatever dot (recorded on the central database system) exists on the line from the border of the circle/or square/or shape corresponding to the outline of the object and the player selected centre.

If further exactitude is required for the instant-win prize, it can be required that a second line be drawn at an angle to the line from the border of the circle/or square/or shape corresponding to the outline of the object to the player-selected centre such that this line crosses the line drawn from the outline of the circle/or square/or shape corresponding to the outline of the object at an angle sufficient to mark a second point designating an area for comparison to the instant prize dot held on the central authentication server designating an instant winning position.

In one embodiment, the player goes to an online available terminal with a display unit which allows him to pick a relevant sport (seen by touch screen) and this relevant scene will be printed on a game card according to the limitations listed above and dispensed to the player. The player then places his handwritten markings on the card as described above and the scene will either be scanned at this on-demand terminal and payment made into a cash collection facility on the terminal, or the printout with the player-inserted markings will be taken to a manned terminal (‘manned terminal’ in this application should be taken to also mean ‘unmanned terminal’ or ‘ATM’), payment handed over and the scene scanned by the manned terminal or scanned by the customer's own mobile phone/PDA. At both the manned terminal and the unmanned terminal the player will have the option of being given a second printout this time with his selected location of the ball marked with a graphical representation of the ball within the printout and a reference code, corresponding to an encrypted unique transaction code on the printout, either across it or outside the sports scene. In addition the scanning terminal will be able to designate and tell the player if he is a winner of the instant prize and will mark the ticket as a winning ticket. The scanning terminal provides an encrypted reference printed on the ticket to the fact that it is a winning ticket and this is capable of being verified on an authentication (central) system.

In an alternative embodiment, the POS terminal where the tickets are printed, is a standalone on-demand machine with touch screen playing a sport sequence. It provides the following options and actions: Firstly pick a sport. Secondly, pick sequence of scenes. Thirdly pick a ball position on screen. Fourthly, the terminal reproduces a ball representation where the player touched the screen and then the player confirms this position. Lastly the terminal prints an etched plastic picture on low-cost light-restricting plastic with a very thin laser hole for the centre where the ball representation is and this is taken to an online connected scanner and two actions are taken. The first action tells the player if they have won an instant prize and the second enters the player's entry into a future draw (optional).

The limitation of scratch cards is that they cannot be very accurate for the spot-the-ball type of games. However, the present embodiment provides a far greater degree of accuracy regardless of the location of the mark. Furthermore, it also allows the spot-the-ball game to be accurately scratched online and lastly it allows the on-demand printer to be remote and away from the POS payment points and of lower security since the winning element is not stored in the printer inviting hackers, but is effectively held in the central authentication system which has included the location and now process involves sending this information to the central authentication database without the winning designation being held locally.

Also a player-engendered circle or other shape with a crosshairs centre is made by the player such that the centre of the crosshairs marks the player's intended selected centre of the ball or object. The instant-win mark is provided along the vertical upper crosshair (upper or lower defined by the relative position to the top or bottom of the drawing relative to the intersection with the horizontal crosshair) or the vertical lower crosshair (similarly defined), or along the left or right horizontal crosshair (again defined according to the relation of left or right of the drawing as defined by the relevant side of the vertical crosshair). In this way, if one of these crosshairs intersects with an instant-win location (only known to the central authentication computer) then an instant prize is paid out. The crosshairs can be required to be extended by the customer to bisect the lines of a “box” framing the scene so that a terminal or mobile device scanning the crosshairs can have a reference starting point.

According to another aspect of the present invention there is provided a method of recording a missing object location within a scene of a gaming card, the method comprising: receiving a scene having a blocked region and a white-space region on the display of a device; determining an outline of an item within the scene; creating a coded identifier for the game card which specifies the location of the outline; block filling in a region defined by the outline; and creating a game card with the scene having the blocked-filled region of the scene in place of the item; thereby reducing the potential area of the scene which is available for player selected location marks to be recorded and presenting information to a scene reading device of which areas in the scene to ignore.

### BRIEF DESCRIPTION OF THE DRAWINGS

The present invention is now described with reference to several different embodiments which are described below with reference to the following drawings, in which:

FIG. 1 is a schematics block diagram showing several different embodiments of the present invention;

FIG. 2 is a flow chart showing the basic method of operation of several of the embodiments shown in FIG. 1;

FIG. 3a is a front view of a scene of a physical game card of FIG. 1, which has a scratch off coating;

FIG. 3b is a front view of a scene of a physical game card of FIG. 1, which has a markable grid area;

FIG. 4a is a front view of a physical scratch game card of FIG. 1, showing most of its scratch-off coating intact;

FIG. 4b is a front view of a physical scratch game card of FIG. 1, showing most of its scratch-off coating removed to reveal a grid of location references;

FIG. 4c is a schematic diagram showing a physical scratch game card of FIG. 1, showing most of its scratch-off coating removed to reveal a grid of location references with an underlying symbol defined by an bold and underlined references;

FIG. 5 is a screen view of a mobile device of FIG. 1, showing a virtual game card;

FIG. 6 is a screenshot of a virtual game card of FIG. 5 showing three sequential scene images and placement of the missing object in the scenes;

FIG. 7a is a schematic screenshot of a virtual game card of FIG. 5 showing a composite scene and the location of the missing objects in the composite scene;

FIG. 7b is a screenshot of a virtual game card of FIG. 5, showing two superimposed sequential scene images and placement of the missing object in the scenes to define an arc of movement of the object;

FIGS. 8a and 8b are a schematic diagrams of a scene of a virtual game card of FIG. 5, showing how the location of the object in blocked space is defined using crosshairs;

FIG. 9 is a schematic screenshot of a scene of a virtual game card of FIG. 5, showing how movement of an object is defined using a track;

FIG. 10 is a schematic screenshot of a scene of a virtual game card of FIG. 5, showing how movement of an object is defined using placement of objects at different locations;

FIG. 11 is a schematic close-up view of the object of FIGS. 9 and 10, showing how an outer and a central region are magnified;

FIG. 12 is a schematic close-up view of the object of FIGS. 9 and 10, showing how one central region is magnified;

FIG. 13 is a schematic close-up view of the object of FIGS. 9 and 10, showing how the pixels of the screen are selected using the central magnification region; and

FIG. 14 is a front view of a physical scratch game card of FIG. 1, showing registration holes and encoded information provided by micro perforations.

### DETAILED DESCRIPTION OF THE PRESENTLY PREFERRED EMBODIMENTS

The present invention is directed to different improvements in an overall concept which has been described above. These improvements address technical problems in the implementation of an instant-win game card on a network of terminals. Some embodiments are implemented using scratch-card technology others without. In some embodiments a virtual game card is used. Several embodiments utilise existing POS terminals or modify existing telecommunications technology to result in an instant-win gaming apparatus solution which overcomes at least some of the problems described in relation to the prior art.

The present embodiments are described using a spot-the-ball type of game. However, the present invention is not restricted to this type of game and can cover any game where there is a scene where an object of the scene has been removed. The references to a ‘ball’ in the present embodiments are meant to also include other objects that are or were in pictures which are then removed for a player subsequently to predict where they were in reality or in the created position in the picture or moving images for them. References to ball or movable object are thus meant to cover any object that has a definable border. Conceptually therefore, a picture of moving swimming heads could be covered by the reference to ball or movable object as a centre could be defined by defining the border and defining the crossing point of the two longest lines within that border. In objects having circular borders, this would be any two drawn diameters. In objects that are not circular, this would be the intersection of the two longest lines starting with the longest line and the next longest line. References to the term ‘picture’ in this aspect are also meant to be references to moving pictures or videos or other form of electronic reproduction or recreation of an animated or moving scene.

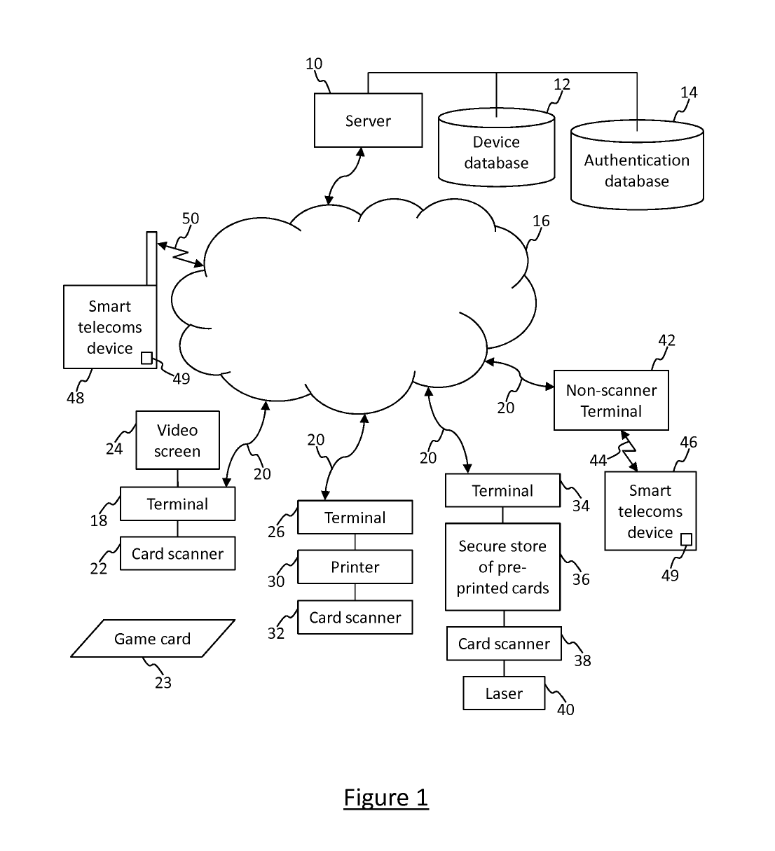

Each of the different embodiments is now described. Referring now to FIG. 1 there is shown a central authentication server 10 having a device database 12 and an authentication database 14. The authentication server 10 acts to authenticate games cards in various forms and provides different ways of conducting that instant-win authentication as will be described below. The information required to conduct the authentication, for example tables of unique game-card identifiers (also known as serial numbers in an embodiment described below) and the relevant stored positions of winning sub-regions for those game cards, are all provided in the authentication database 14. The device database 12 stores configuration details of models of mobile telecommunications devices such as mobile phones, smart phones, tablet computers etc. and details regarding their screen size and the relevant scales used for their graduated axes. It is to be appreciated that different mobile devices have different screen sizes and resolutions and hence the relevant scale used for different types of device can be different. This in turn determines the size of the scene which can be displayed and hence the size and scale of the graduated axes (described later) which can be applied for example to a virtual electronic game card.

The authentication server 10 is in use connected via a wide-area communication network 16 such as a PSTN (Public Switched Telephone Network) to a plurality of different terminals and devices. FIG. 1 shows five different types of devices connected with the authentication server 10 via the communications network 16. Each of these devices represents one embodiment and each is described below in turn together with the way in which each device is used to implement embodiments are described.

The first device is a low-cost retail terminal 18 which has a PSTN dial-up communication link 20 with the central server 10. The terminal 18 also has a game card scanner 22 and a low-cost image display screen 24. The terminal 18 which is provided at a point of sale (POS) can run a video sequence on its screen and can pick at least one frame from the video. The terminal then prints the at least one video frame as a scene on a game card 23 and dispenses this to the player. The game card 23 can be a scratch card which arranged to have a sub-region of the scene scratched off or simple thermographic paper game cards which can be manually marked by the player. In either case, the player-marked game card 23 can be scanned by the scanner 22 and the game card information transmitted to the authentication server 10.

The second device is a retail terminal 26 which also has a PSTN dial-up communication link 20 with the central server 10. The terminal 26 has a printer 30 for printing game cards 23 also has a game card scanner 32. This printer 30 is used to print game cards 23 on demand whether they are scratch cards or simple thermographic paper game cards as have been described above. The player-marked game card 23 is then scanned by the scanner 32 and the game card information transmitted to the authentication server 10.

The third device is a low-cost retail terminal 34 which has a PSTN dial-up communication link 20 with the central server 10. The terminal 34 has a store 36 of pre-printed game cards for dispensing to the player on demand. A game card scanner 38 is also provided together with a low-cost laser 40 in the form of a laser diode to reduce costs. This store 36 dispenses game cards on demand whether they are scratch cards or simple pre-printed game cards. The game cards 23 depict different video scenes and the terminal simply issues an appropriate game card 23 and this can be based on player selection. As in the above described devices the player-marked game card 23 can be scanned by the card scanner 38 and the game card information transmitted via the communications network 16 to the authentication server 10.

It is to be appreciated that when the terminal does not physically print out the game card 23 on demand, the substrate on which the game card 23 is provided does not need to be comprised of thermographic paper. It can be comprised of a cardboard material for example. In this third device, where the game cards are not printed on demand only dispensed on demand, the store comprises game cards which are not provided on thermographic paper.

The fourth device is a low-cost non-scanner terminal 42 which also has a low-cost PSTN dial-up communication link 20 with the central server 10. The low-cost terminal 42 is provided at a retailer and has a capability to communicate wirelessly via a local area wireless communications network 44 such as WiFi of Blutooth with a smart portable mobile telecommunications device 46, such as a smart phone, a tablet computer or even an e-book (such as an Amazon Kindle® or a Kobo e-Reader® or an Apple iPod Touch®). The smart portable telecommunications device 46 may have a local application (app 49) provided which has been downloaded onto the device previously. This would enable an electronic game card (not shown) to be provided on the player's smart telecommunications device 46. The player could interact with the device to attempt to locate the position of the missing object and submit this as their entry into the instant-win game by transmitting this back to the terminal over the local area communications network 44. The instant-win aspect in this case would be possible by a winning entry being sent to the authentication server 10 by the terminal 42, being authenticated by the server and thereafter authorising the retailer with the non-scanner terminal 42 to provide the instant prize to the player.

The fifth device is a smart telecoms device 48, such as a smart phone, a tablet computer or even an e-book (such as an Amazon Kindle®, a Kobo e-Reader® or an Apple iPod Touch®), and has a capability to communicate wirelessly via a mobile telecommunications channel 50 and the wide area communications network 16 to the server 10 to participate in the instant-win game. However, the mobile telecommunications channel 50 is preferably not a 3G/4G data connection via the internet but is rather a data connection which uses GPRS such as an SMS data messaging connection. This type of connection advantageously has a far lower cost and is more widely available throughout the world than an internet connection. The device would be the player's own device. However, the smart telecommunications device 48 may also have a local application (app 49) provided by the server 10 which has been downloaded onto the device 48 previously. This would also enable an electronic game card to be provided on the player's smart telecommunications device 48. The instant-win aspect in this case would be possible by a winning entry being authenticated by the server 10 and thereafter the device 48 being sent a redemption identifier (such as an alphanumeric code or a 2D-barcode—not shown). The redemption identifier could then be provided to a retailer with a scanner terminal 18, 26, 34, sending the redemption identifier to the authentication server 10 and thereafter the player receiving the instant prize if the authentication server 10 confirms that the redemption identifier is valid and unused. It would also be possible for the smart telecommunication device 48 to use the non-scanner terminal 42 if the redemption identifier could be transmitted to the non-scanner terminal via the local communications network 44.

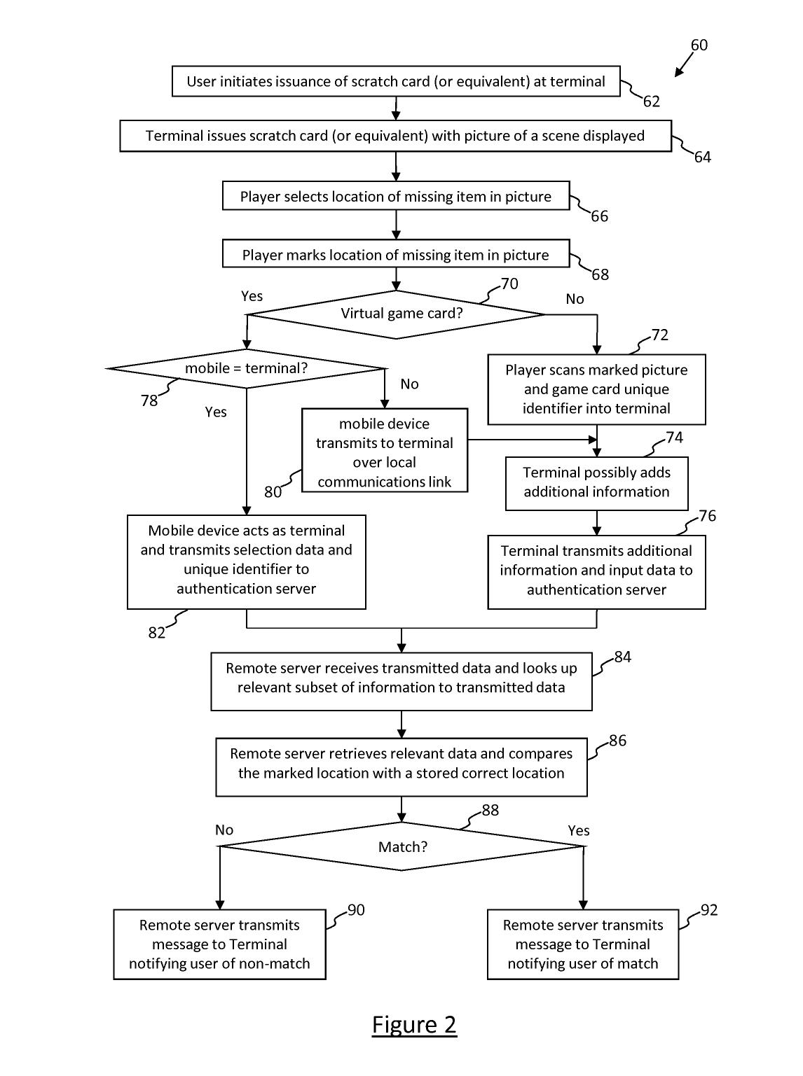

Having briefly described the apparatus used for supporting most of the embodiments described, a general method 60 of operation of these devices in handling a game card is now described with reference to FIG. 2.

The method 60 commences with the player initiating at Step 62 issuance of a game card 23 with a picture of a scene displayed on the game card. The game card 23 can be a scratch card with the scene overlaying a scratch-off coating, a printed scene on the game card substrate or a virtual ticket in the form of a displayed image of a game card on a player's own mobile device 46, 48. The terminal then at Step 64 issues the game card 23 by either dispensing or printing the same. In the case of a virtual (electronic) game card, the dispensing terminal may be the mobile device 48 itself, configured by the downloaded app 49 to present an image of the game card on the mobile device screen. Once the game card 23 had been provided to the player, they then using their skill and judgement select at Step 66 the location of the missing item from the scene and mark at Step 68 the game card 23 with their selection (selection data).

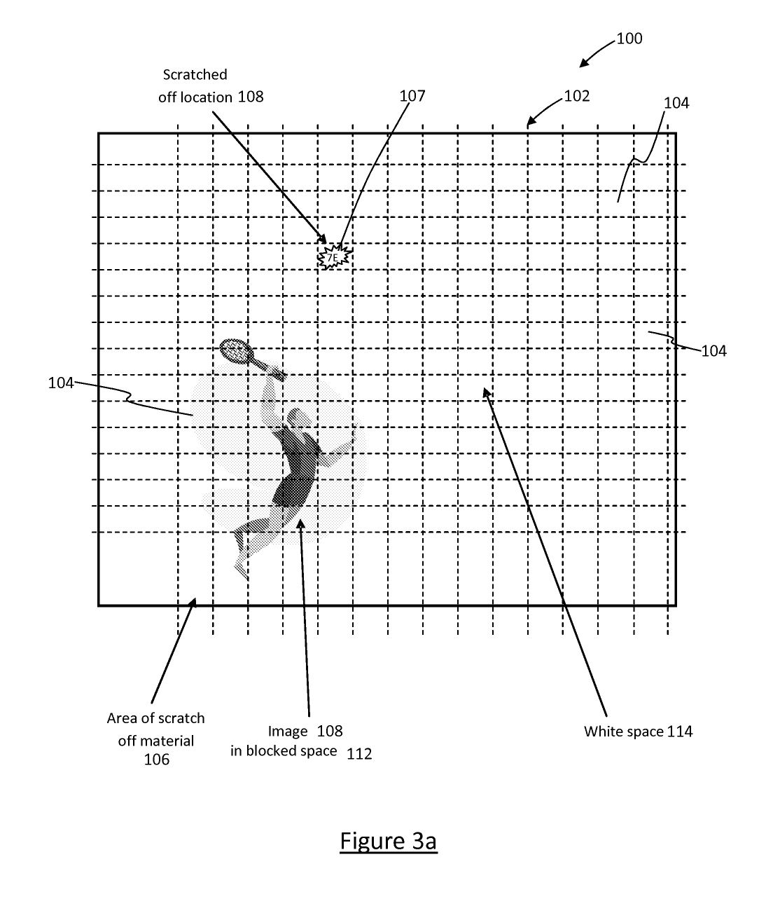

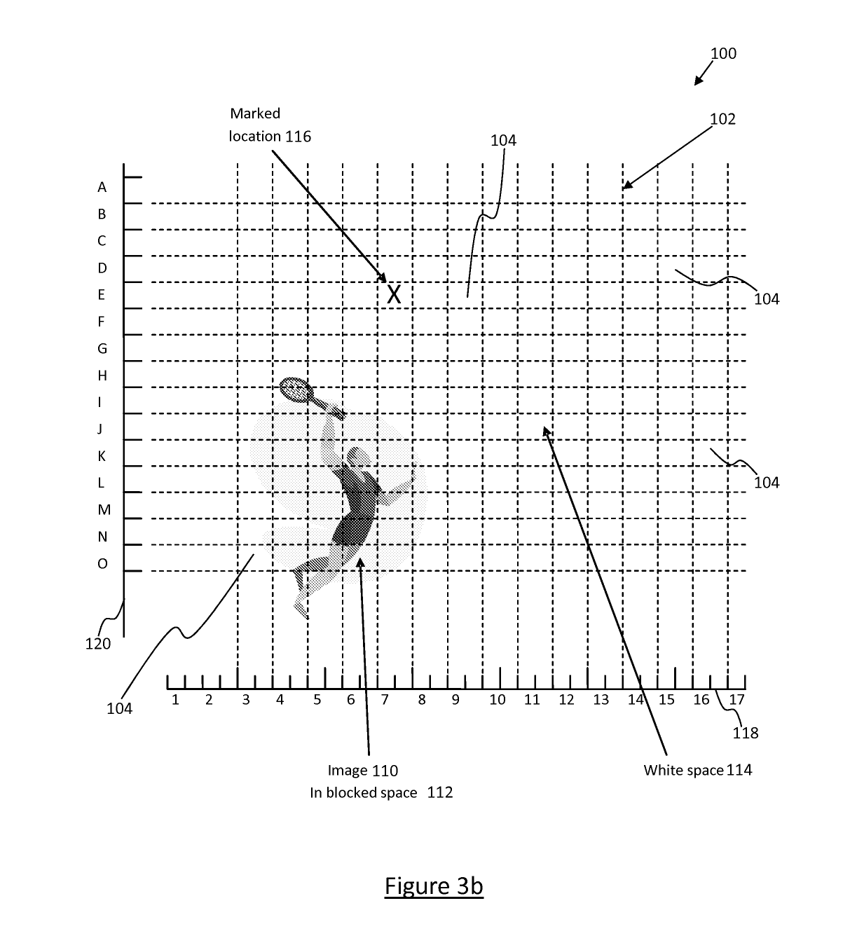

The player then seeks to enter their selection data into the system. If it is determined at Step 70 that the game card 23 is not a virtual game card (namely a physical game card) then there are always at least two steps carried out, namely scanning at Step 72 the physical card into the terminal 18, 26, 34 connected to the authentication server 10 and then the terminal transmitting at Step 76 the scanned data to the authentication server 10 via the communications network 16. The scanned data not only includes the player selection data but also the unique identifier of the game card, namely in this embodiment its serial number (see FIG. 3a).

Alternatively for a virtual game card determined at Step 70, which is displayed on a player mobile device 46, 48, the transfer may involve at least one or at least two steps depending on whether the mobile device 46, 48 is acting as a terminal itself which is determined at Step 78. When the mobile device 46 is not acting as a terminal, then the electronic data representing the player's section data and the unique identifier of the virtual game card are transmitted at Step 80 to the terminal 42 via the local communications link 44. The terminal 42 then transmits at Step 76 the received information to the authentication server 10 via the communications network 16. If however, the mobile device 48 is also acting as the terminal as determined at Step 80, then the electronic data representing the player's section data and the unique identifier of the virtual game card are transmitted at Step 82 to the authentication server 10 via the mobile telecommunications channel 50 and the communications network 16. This, in some preferable low-cost embodiments, can be as an SMS message but in some more costly embodiments can be as an MMS message.

Optionally, the terminal 18, 26, 34, 42 may add at Step 74 additional data to that to be transmitted to the authentication server 10. This additional data may include terminal identification data or a unique terminal security code, a timestamp, a geographic locator and other information which may help uniquely identity the terminal to improve authentication procedures. This additional information can also be included in the mobile data transmission at Step 82 when the mobile device is acting as a terminal. In this case, the mobile device MEI can be provided as can the location using GPS data present on the mobile device.

Subsequently, when the player selection data and unique game-card identifier data is received at Step 84 of the method 60, the unique game-card identifier information is used to lookup the relevant subset of information that is associated with the unique game-card identifier. Typically, this data will include the correct location of the sub-region of the scene which is provided on the game card 23 from where the object has been removed. This relevant subset of information is then used by the authentication server 10 to compare at Step 86 against the player's selection data to determine at Step 88 if there is a match.

If there is no match (or the player selection data indicates a sub-region which is not within a range of the correct sub-region) then the authentication server 10 sends at Step 90 a message back to the terminal from which the player's selection data was sent indicating that in the present case the player has not been successful in this attempt to determine the location as there was no match. If there is a match (or the player selection data indicates a sub-region is within a range of the correct sub-region) then the authentication server 10 sends at Step 92 a message back to the terminal from which the player's selection data was sent indicating that in the present case the player has been successful in this attempt to determine the location as there was a match. In this case, the player may be presented with an instant-win prize for the game card entry by the operator of the terminal, namely the retailer at the POS.

In the case of a virtual ticket where the mobile device 46, 48 is acting as a terminal, the message indicating that there has been a match is also accompanied by a unique match identifier in the form of an alphanumeric code or a graphical identifier (such as a 2D-barcode) which can be displayed on the player's device. The player then goes to the POS where a retailer has a terminal and the code is entered into the terminal (or scanned in in the case of a graphical identifier) and sent by the terminal to the authentication server 10. The server 10 validates that the unique match identifier is valid, unused and correct and authorises the retailer (operator of the terminal) to present the player with an instant-win prize for the game card entry.

The unique identifier of the game card 23 and the correct coordinates of the winning position within the scene 100 (to be guessed and indicated by the player) are known only to the authentication server 10 (being stored in the authentication database 14) which avoids fraudulent attempts to win an instant prize but at the same time permits for a genuine winning game card 23 to be recognised. This also advantageously eliminates the human factor in traditional spot-the-ball competitions that famously were open to considerable fraud.

The above described apparatus and methods for providing a game card at a POS can be used to provide a physical game card 23 in the form a scratch card or a non-scratch game card 23 on thermographic paper (or equivalent). In the case of the scratch-card embodiment, the scene is provided on the scratch-off coating of the scratch card and this is described in greater detail below with reference to FIG. 3a. For the non-scratch off coating game card, an example is provided with reference to FIG. 3b. Much of the description of the physical game cards can also be used for the virtual game card which is provided in electronic form, and so only the differences will be elaborated on later in this description.

Referring to FIGS. 3a and 3b the scene 100 provided on the game card 23 comprises an array 102 of very small individual squares 104 that are capable of being read by the scanner 22, 32, 38 provided with the terminal 18, 26, 34. Each of the squares 104 are almost the size of a few pixels or are sufficiently large to be read by the scanner 22, 32, 38. In the scratch-off embodiment shown in FIG. 3a, the scratch-off coating is applied over a given area 106 of the game card and each square 104 of the array 102 provided on the scratch-off coating area 106 has an alphanumeric code 107 underlying it which can be read by the scanner 22, 32, 38 after the scratch-off coating has been removed at the desired location 108. In FIG. 3a, the alphanumeric code ‘7E’ 107 is revealed by scratching off a desired location within the array 102. The scene 100 is made up of an image 110 which may be provided in blocked space 112 (where a positive image is provided) and white space 114 (where there is no positive image provided).

In an alternative non-scratch-off embodiment shown in FIG. 3b, another method of locating the ball is for the player to mark the game card 23 at the location 116 where the missing object is believe to be. In this case the scanner effectively reads the whole scene 100 and records the coordinates of the relevant centre of the location square 116 either punched out or marked in this embodiment by a cross. The scene 100 has a border with graduated axes 118, 120 which comprise alphanumeric or numeric references. The graduated axes 118, 120 allow a location point 116 to be given for the centre of an object (such as a tennis ball in this embodiment) which is not in the scene 100. The graduated axes 118, 120 referencing each square 104 are provided almost as background relief so as not to distract the player from the scene 100.

In an alternative embodiment, the desired location 116 can be determined and expressed as reference points on the graduated axes 118, 120 by crossing off the values from a list of pre-printed reference point numbers/letters, akin to using a normal lottery transaction/wagering slip to pick numbers. This can be carried out in addition to or alternatively from the centre point of the missing ball being indicated at the marked location 116 as referred to above. Also an additional or attached paper transaction slip (not shown) can be provided to record the coordinates of the marked location 116 which are determined from the graduated axes 118, 120.

The game card 23 is “valueless” at this point since it has not been authenticated by the authorisation server 10. In order to achieve that authentication, the physical game card 23 has to go through a scanning process which in turn requires payment to the retailer. Once scanned in, the card information including the player's choice of location 108, 116, is presented to the authentication server 10 to activate the game card 23 and confirm the instant-win prize entry. The central server 10 examines the received reference details of the game card 23 (namely its unique identifier), knows that on that particular game card the winning position is marked by the scratched-off position alphanumeric code ‘7E’ 107 (which on other game cards is a different reference) and the authentication server 10 thus knows instantly not only whether the game card entry is a winner or not but also whether it is a valid game card. For a winning card, an authentication message can be sent back to the requesting terminal 18, 26, 34 confirming to the retailer that the entry is a winning entry and that the instant prize should be provided to the player.

In an alternative embodiment it is also possible for the player to use his own mobile communications device 46, 48 and transmit game card reference details to the authentication server 10. This can be carried out either by using a camera (not shown) provided on the mobile device 46, 48 to capture an image of the unique machine-readable game card identifier (which can be the alphanumeric serial number or a bar/QR code). The information is then extracted from the identifier and transmitted with the marked reference position 108, 116 to the authentication server 10. The camera operation, information extraction from the image and control of communication to the authentication server are controlled by the app 49 of the mobile communications device 46, 48. The communications can be direct via the mobile telecommunications channel 50 or indirect via the non-terminal scanner 42 (using the local area wireless communications network 44 as has been described above).

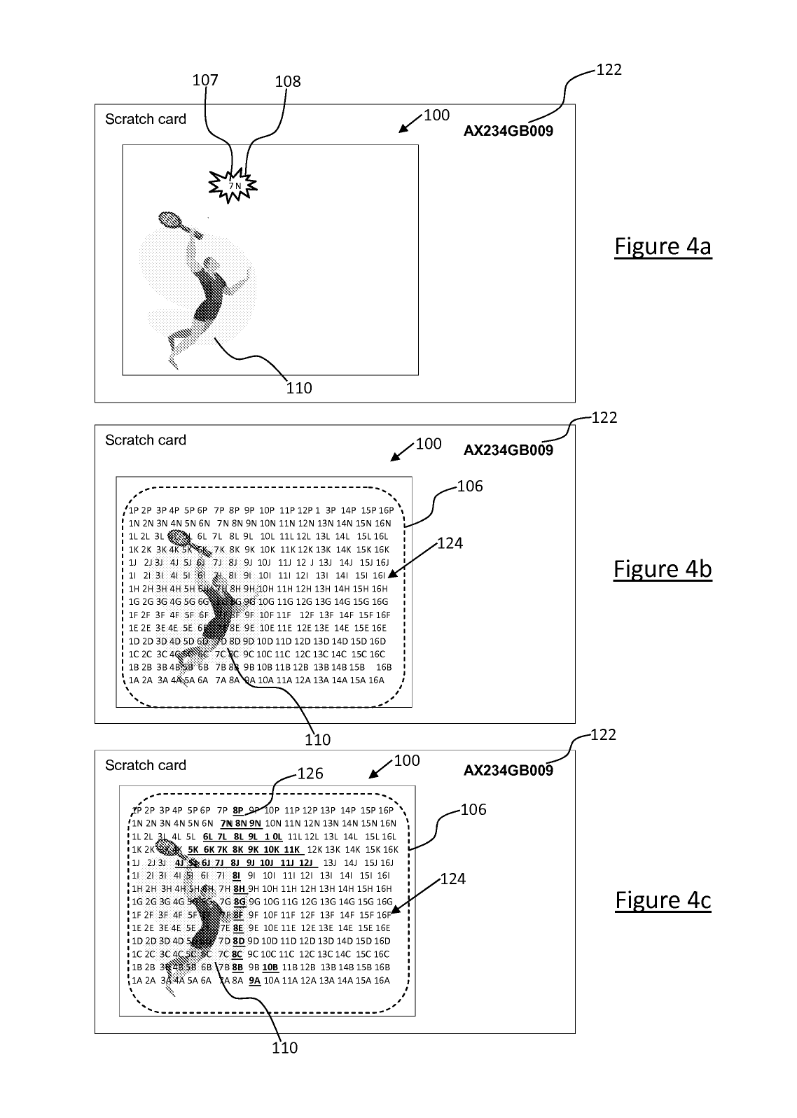

In another embodiment described with reference to FIGS. 4a, 4b and 4c, a scratch card 23 is shown. The scratch card has the unique identifier (serial number) 122 and a scratch-off scene 100 which has already been described with reference to FIG. 3a. This embodiment enables the player to select a location 108 by scratching off a sub-region 104 of the scene 100 as is shown in FIG. 4a. However, to prevent a third party taking the marked location 108 of a winning game card and re-applying that knowledge to the same or similar scene 100 of other game cards 23, a two-stage scanning process can be required to authenticate the game card 23 at the terminal. The first stage would be as that described previously with reference to FIG. 2, namely the player first scratches off the specific location 108 (sub-region) to reveal the alphanumeric code 107. The game card 23 is then scanned by the terminal. A second stage would require the player to scratch off the coating 104 over the entire scene 100 to reveal an array 124 all of the possible alphanumeric codes as is shown in FIG. 4b. This would ensure that any discarded winning game cards 23 would effectively hide the winning selected location 108. The game card 23 would then be rescanned to confirm that this step had been taken in order to enable the retailer to present the instant prize to the player.

A variation of the above described procedure is also possible as shown in FIG. 4c. In this case, the array of alphanumeric codes 124 would have within them a much larger number/symbol 126 that only can be revealed by scratching off the entire scratch-off coating over the scene 100. In this case, the larger symbol is an umbrella and is recognisable as the alphanumeric codes for these locations are underlined and in bold. However, there are many different ways in which the large number/symbol 126 can be represented and this feature is not restricted to the exemplary manner it is presented in FIG. 4C. For example, the larger image 126 can be a semi-transparent background image which does not interfere with the function of the alphanumeric codes array 124 but which is readily apparent in a machine-readable manner to the electronic scanner. In this embodiment the two-stage scanning would also be required, and the game card 23 on its second scan would read the much larger number/symbol 126 which would also be transmitted to the authentication server 10.

To reduce the risk of fraud, there is in this embodiment a changing large number/symbol 126 per game card 23 and whilst it is not shown the grid reference (namely the array of alphanumeric codes 124) would also change for each game card 23. This means that whilst the missing ball location could be the same on some game cards 23 which happen to show the same scene 100, the manner in which that is expressed to the authentication server 10 changes per game card. This in turn prevents players and other third parties from using a winning game card location to obtain multiple winning entries without any skill and judgement.

If the scanning of the game card 23 is carried out using the terminal 34 which has a laser 40, in an alternative to requiring the player to scratch-off the entire covering over the scene 100, and rescan the game card 23, the terminal 34 can be configured to use the laser 40 to obliterate the scene 100 after the player's selected location 108 has been read by the scanner 38. This action prevents copying of a winning location to other game cards 23.

In another embodiment, the scratch card terminal 34 is operated in a future draw mode. Firstly, a player pays by cash or credit card for the game card 23 and gets out a scratch card from the secure store 36 of pre-printed game cards 23. The player then scratches off the position he/she considers to be the winning location and takes it to the manned terminal 34. Here, the scratch card 23 is scanned-in via the card scanner 38 and a ticket receipt is produced with a unique transaction number and the winning unique transaction number is announced at some point later as a winner. This is a future draw concept—described in greater detail later.

Also in another embodiment, the scratch card is provided loose (namely provided freely for example from an open display—not in a secure store 38). However, at this point the game card has no value and is not worth stealing. The game card 23 is then scratched and fed into the automated scanner together with a lottery ticket/investment certificate. Alternatively a transaction slip can be used which can permit purchase of lottery ticket/investment certificate. The transaction slip in this case would contain the player's selected information e.g. details of the player and/or choices of numbers for a prize draw as per a lottery selection process. The terminal then generates a unique transaction identifier (x), associated with the lottery ticket/investment certificate (or selections thereto) and the unique identifier (y) of the scratch card 23, which is encoded onto a second ticket which can be a new lottery ticket for example. This second ticket is then printed and includes a unique reference number (z) which is a function of the unique transaction identifier (x) and the scratch card identifier (y) (namely z=ƒ(x,y)). This is issued with the original lottery ticket returned or a new ticket/certificate printed with the existing information from the lottery ticket and the scratch card transaction number (x). So the scratched card is returned with the new multiple-function second ticket. In this embodiment, in due course the winning picture is released together with the unique reference number of the second ticket printed by the automated scanner.

In another embodiment, the scene 100 on the scratch card 23 can be made up of micro-numbers such that it is then possible to print these numbers in different shades of black and grey to provide the necessary contrast to print the picture. In this embodiment, when the relevant position is crossed out, the symbol for the scanner is located by effectively locating all the other micro-number squares.

In another alternative embodiment which relates to the electronic virtual game card mentioned above, the game can be played on the mobile device 46, 48. Virtual game cards are more secure than printed physical game cards because there is a far greater degree of variation in the scene possible. For example, video footage of a sporting event which is composed of hundreds of thousands of different scenes in the form of video frames can be used as a source of scenes. As such, it is possible to make almost each different virtual game card based on a unique scene 100 such that the ability to carry out fraudulent activity by knowledge of a winning location in a previous virtual game card becomes virtually zero. However, the trade-off for virtual game cards is cost, as slightly more expensive terminals 18 with video screens 24 may be required or mobile devices 46, 48 with the ability to act as a terminal. Such cost consideration is not an issue where the embodiment is retrofitted to devices which already exist and which have the requisite video display features. So in the case of a mobile device 46, 48 there may be no additional costs as the player already has their own mobile device which they can use as a terminal for the virtual game card. Also where a fixed terminal exists with a display screen which can display video scenes, then this can be merely reconfigured to be used as a game card terminal without substantial additional cost.

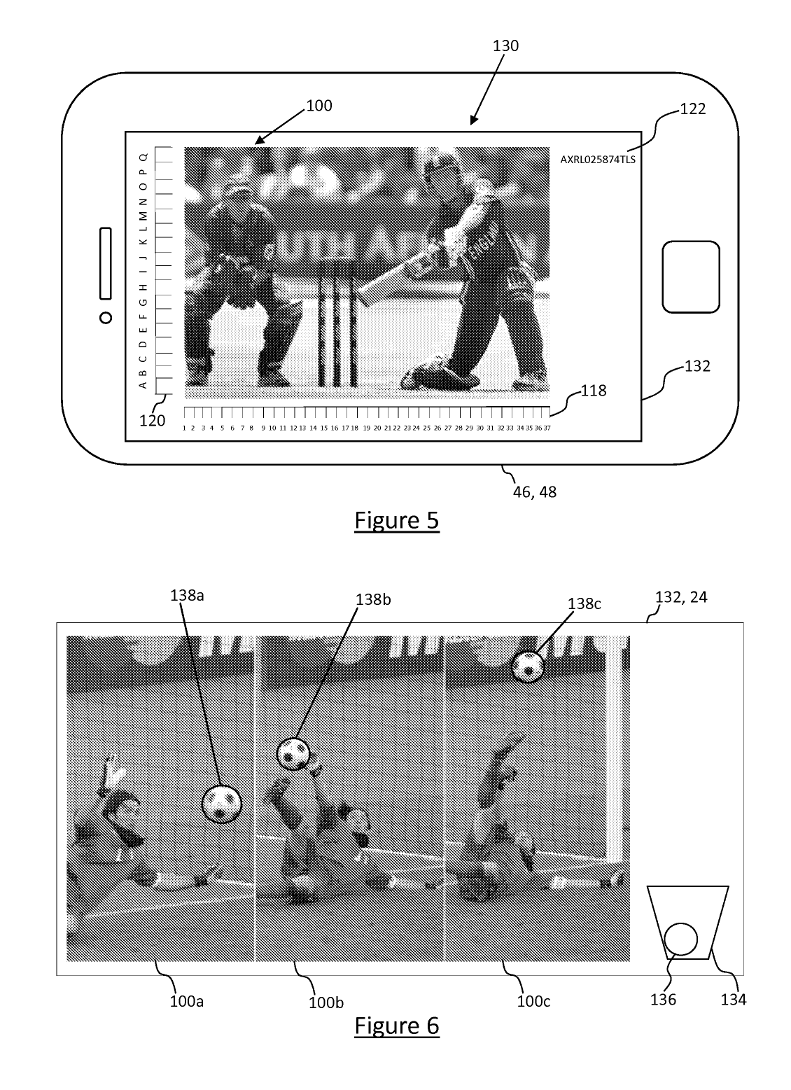

A generic mobile app-controlled virtual game card 130 displayed on a screen 132 of the mobile device 46, 48 is shown in FIG. 5. Here the relevant alphanumeric code 107 of the selected location 116 (not shown in FIG. 5) can determined by the player according to the graduated axes 118, 120 provided on the periphery of the scene 100 in a similar manner to that shown in FIG. 3b. The screen 132 is typically a touch screen such that player selection of the missing object location can be determined by appropriate interaction with the touch screen 132. However, this can raise issues of accuracy which are addressed in embodiments described later. The solutions described in these later embodiments can readily be applied in the present embodiment.

Also the unique identifier 122 is provided for the virtual game card 130 which may or may not be displayed on the mobile device 46, 48. Regardless of whether the unique identifier 122 of the virtual game card 130 is displayed, it is associated with each virtual game card 130 and is always used during the uploading of the virtual game card data to the authentication server 10, to uniquely identify the virtual game card 130.

In the mobile device embodiments, where the mobile device 48 is acting as a terminal, payment for the player's submission of the instant gaming virtual game card 130 can be achieved by way of relevant charges simply being added to the player's mobile phone billing account.

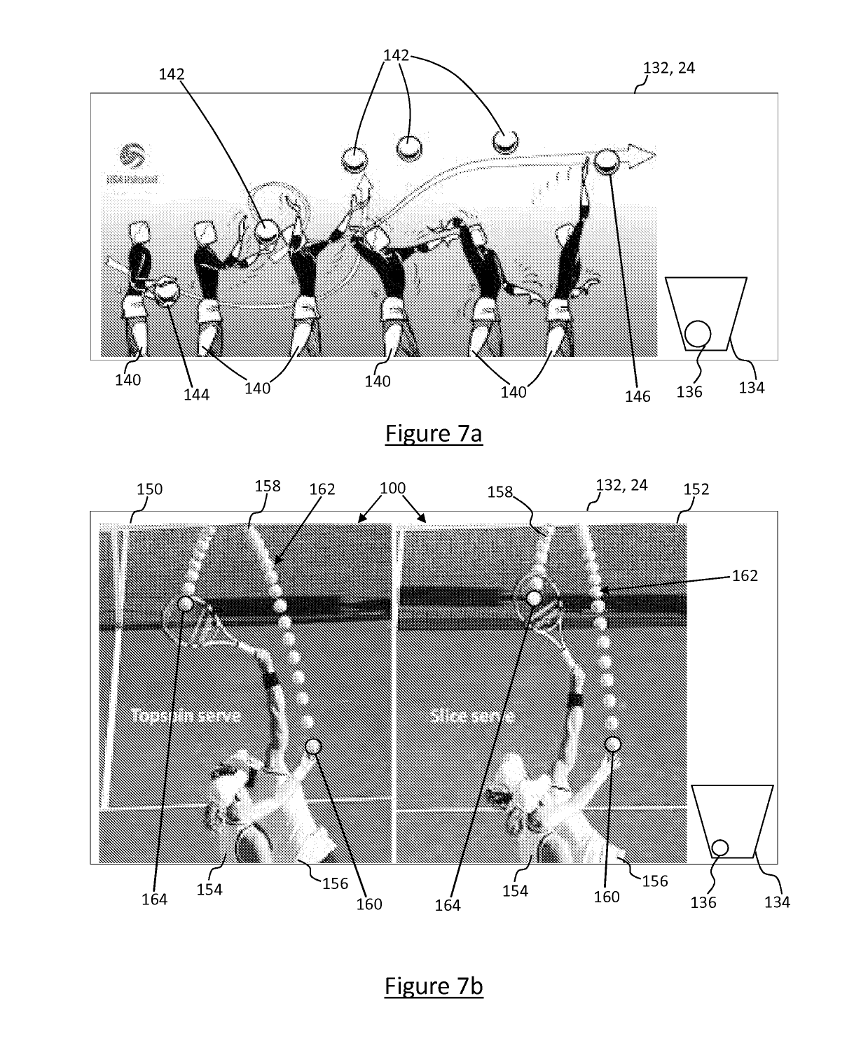

Referring now to FIG. 6, in another embodiment which is provided on the mobile device 46, 48, or any other electronic device having a screen 132, 24 (such as the terminal 18), the player is presented with the virtual game card 130 on the screen 132, 24 of the device 46, 48, 24. In this embodiment the player can be assisted in visualising the location of the missing object (ball). This is possible by the provision of a container 134 located on screen 132 which is positioned outside the scene 100. In the container 134 is provided a graphical representation 136 of the missing ball. The graphical representation 136 is sized to match the size of the ball which has been removed from the scene 100. In use, the player selects the ball representation 136 in the container 134, typically using touchscreen technology or a human interface pointing device e.g. a mouse or cursor etc., and moves the ball representation 136 to the desired location, where the player considers using his or her skill and judgement that the ball would have been in the scene 100. The player can adjust the location of the ball representation 136 in the scene 100 until they are satisfied that they wish to use the location of the graphical ball representation 136 as the marked location 116 of the missing ball. Then the ball position represented by a location reference within the scene 100 can be fixed (the player actuates a button on the touch screen (not shown) to indicate the fixing of the location) and the virtual game card entry made submitting that player-selected location reference.

In FIG. 6, three scenes 100a, 100b, 100c are provided which sequence a chain of events relating to the sporting event. In each scene the ball has been removed. The player selects the ball representation 136 in the container 134 and drags it to a first position 138a within the first scene 100a where the missing ball is believed to be. This is then repeated for the other two remaining scenes 100b, 100c to result in the selection of a second position 138b and a third position 138c respectively. The three selected positions 138a, 138b, 138c define a path of travel of the ball over time through the scenes. This path of travel can provide a further game for virtual game cards 130 in that the player selected-path closest to the actual path known only to the authentication server 10, can also win a prize. FIG. 6 shows the ball representation 136 after it has been placed within the scenes 100a, 100b, 100c at the respective positions 138a, 138b, 138c.

The path-of-travel additional game can realised in different forms. Two examples of these are now discussed with reference to FIGS. 7a and 7b. In FIG. 7a a series of six snapshots of a sportsman 140 are provided within a scene 100. Each snapshot of the sportsman 140 is always taken from the same location and each represents the sportsman's interaction with a volleyball 142 at a given time during the process of serving. The six snapshots each have associated with them a correct location for the volleyball 142 which are shown in FIG. 7a (for convenience only) but which would be removed from the scene 100 presented to the player in the implementation of the embodiment. As in the embodiment described in FIG. 6, the player would select the ball representation 136 in the container 134 provided at the side of the scene 100 and drag or otherwise position the ball representation 136 to the location which best represented their guess at the missing volleyball location, namely their marked location 116 for data entry. This would be repeated for each of the six snapshots within the scene 100. The first location 144 and the last volleyball location 146 of the player selected path are in this embodiment relatively easy to guess as the volleyball 142 is to be in contact with the sportsman's hands. These volleyball locations would then form the recordable and/or displayable path across the scene 100 which would be transmitted as part of the player entry into the instant-win game. The authentication server 10 would compare the player-selected path with the correct volleyball path and the closest player selected path to the actual hidden (or removed or previously removed) path would also win a prize. The selected locations for the volleyball 142 create a digital path of references (grid locations). These locations can be defined as the mid-points of fixed points on the graduated axes 118, 120 (not shown) at the edge of the scene 100.

In FIG. 7b two types of tennis serve are depicted in the two side-by-side scenes 100 which are shown. The first scene 150 represents a ‘topspin’ serve and the second scene 152 represents a ‘slice’ serve. In each of these scenes 150, 152 two superimposed images are shown: a first image 154 with the sportswoman at the start of the serve and a second image 156 with the sportswoman at the end of the serve when a tennis ball 158 is hit. The first and second images have associated with them a correct location for the tennis ball 158 which are shown in FIG. 7b (for convenience only) but which would be removed from the scene 100 which was presented to the player in the implementation of the embodiment. As in the embodiment described in FIG. 6, the player would select the ball representation 136 in the container 134 provided at the side of the scenes 150, 152 and drag or otherwise position the ball representation 136 to the location which best represented their guess at a start position 160 of the ball toss. They would then trace the arc of movement 162 of the tennis ball 158 from the start position 160 to an end position 164 where the tennis ball 158 is struck by the tennis racquet, for data entry. As the player traces the arc 162, the screen 132, 24 can display the arc 162 to the player to provide feedback as to their data entry. As before the selected locations for the tennis ball 158 create a digital path of references (grid locations) representing the arc 162 which are compared by the authentication server 10 to the correct locations stored at the authentication database 14. It is to be appreciated that in this form, the present embodiment could also be implemented on a physical game card. In such an implementation, the locations of the arc 162 could be marked on the game card as a line which could be scanned to digitise the ball locations for comparison with the correct locations provided at the authentication server 10.

In another embodiment, it is possible for the terminal 18 to provide the player with a choice of sports and within a selected sport, a plurality of possible scenes. The player can select a desired scene from within a selected sport and play the instant-win game using that frame. In addition, it is possible from the game to have a subsequent draw/selection process aspect as well as the instant-win aspect. It may be that there is a minimum of one entry per type of sport picked and this is purveyed on both an instant and a subsequent draw/selection process to designate the winning entry.

In each of the virtual game card embodiments described herein, there is a technical issue which is addressed by the present embodiments. The difficulty is that not all mobile devices have the same framing reference (different sizes/resolutions of displayable scenes and therefore different graduated axes 118, 120) for the scene 100 which is displayed on their screens. For example, an Apple iPad® will have a much larger screen size than a Samsung S2® smart phone for displaying the scene and they may have different screen resolutions. In both cases it is desired to use the maximum available screen size and hence the array 102 of very small individual squares 104 will have different ranges on its graduated axes 118, 120.

The present embodiments overcome this by providing an artificial composite framing reference (not shown) of the player-selected location of the missing object/ball. An original framing reference is provided in terms of the graduated axes 118, 120 being used in the current displayed scene 100, namely a grid reference expressed in terms of the graduated axes 118, 120 used. However, this original framing reference, in the form of digital information, is combined with a unique device identifier and a location reference to create the unique number—which is the artificial composite framing reference of the gaming entry. The composite framing reference itself identifies the mobile device 46, 48 or terminal 18 on which the virtual game card 130 is being presented (fixed terminals can also be identified by virtue of their location). Once this composite framing reference is received at the authentication server 10, it is decomposed into a grid reference and the identifiers for the mobile device 46, 48 or the terminal 18. The device identifier is then used to look up the device 46, 48 or terminal 18 in the device database 12 and its associated known screen size/resolution (stored in a look-up-table) which determines the size of its graduated axes 118, 120. The retrieved known graduated axes 118, 120 for the device 46, 48 or terminal 18 being used can then be used to translate the grid reference, which is the player's entry, into the same size array as the correct answers which are stored in the authentication database 14, such that a valid like-for-like comparison can be made between the gaming entry and the known correct location for that particular scene 100.

In a further embodiment, it is possible to link the game entry to a medium, short or long-term financial instrument. In this case, the ball/object is moved by touch or other human interface device on a screen 24 in store to the desired location as has been described in any of the other embodiments described herein. In addition, the terminal's scanner 22 is then used to scan a financial instrument document and to read a unique serial number or general reference number of the financial instrument document. The gaming entry can thus be linked to the financial instrument by this process and both types of information can be processed at the authentication server 10. Similarly the financial instrument document can be replaced by an identification document (such as a driving license or passport) which can be scanned in its place. This embodiment can thus be used for both potentially a lottery and/or Islamic investment and or/other form of investment product.

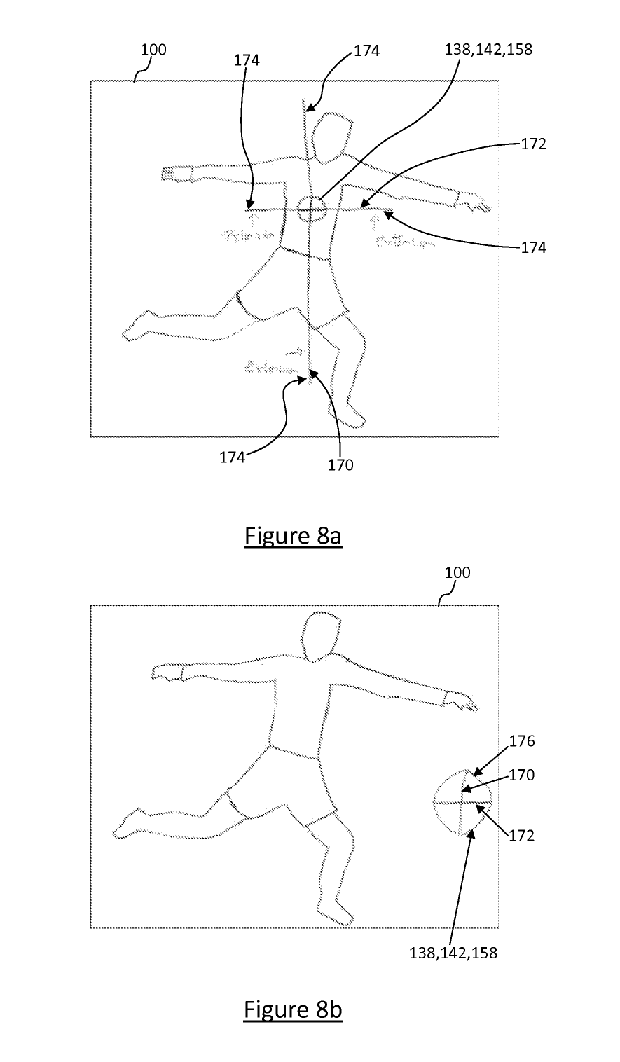

In another embodiment, which is now described generally with references to FIGS. 8a and 8b, a higher degree of accuracy in selection of the marked location 116 is possible, particularly for terminals 18 and mobile devices 46, 48 having a relatively small size of screen 24, 132. In this embodiment, the ball or object 138, 142, 158, has vertical and horizontal crosshairs 170, 172 running through it. As shown in FIG. 8a, each of the crosshairs 170, 172 extend outside the perimeter of the ball/object 138, 142, 158, to enable the ball to be dragged and dropped into position by the player interacting with the screen 24, 132. The ball is typically moved to the desired location using the crosshairs 170, 172. When a touch screen is used (most common) the crosshairs provide a “grip” point (along the crosshair length) outside the ball/object so the player can position the crosshairs 170, 172 accurately using their fingertips. The grip point can be realised one crosshair at a time, for example locating the vertical crosshair 170 first and then locating the horizontal crosshair 172. Alternatively, both crosshairs 170, 172 can be located simultaneously by the player using two fingers on the touch screen at the same time. In this case, the rightmost contact point on the screen 24, 132 could represent the horizontal crosshair grip point and the lowermost contact point on the screen could represent the vertical crosshair grip point. It is possible for the player also to “touch” the general location where it is desired to place the ball 138, 142, 158, then to move the position of the ball 138, 142, 158 by touching and pulling the crosshairs 170, 172 using any one of the four ends 174 of the two bisecting lines making up the crosshairs, thus obtaining an exact positioning of the ball 138, 142, 158 whilst avoiding obscuring or the player losing eye contact with the desired exact placement point during the object/ball placement exercise as performed by the player. Once the object/ball 138, 142, 158 has been placed in the desired location 176 by the player, the crosshairs 170, 172 can retract to within the object 138, 143, 158 as shown in FIG. 8b to enable the player to view the scene and confirm the selected location 176 without undue disturbance from the extended crosshairs 170, 172.

The use of such extended crosshairs 170, 172 mitigates the problem of the player obscuring their vision of the actual marked entry location being selected due to the size of their finger on the screen 24, 132 relative to the size of the ball/object which would make selection difficult or not practicable in a short time frame. This problem can in the worst case lead to several failed attempts frustrating the player to the point where he/she abandons the effort to play the game.

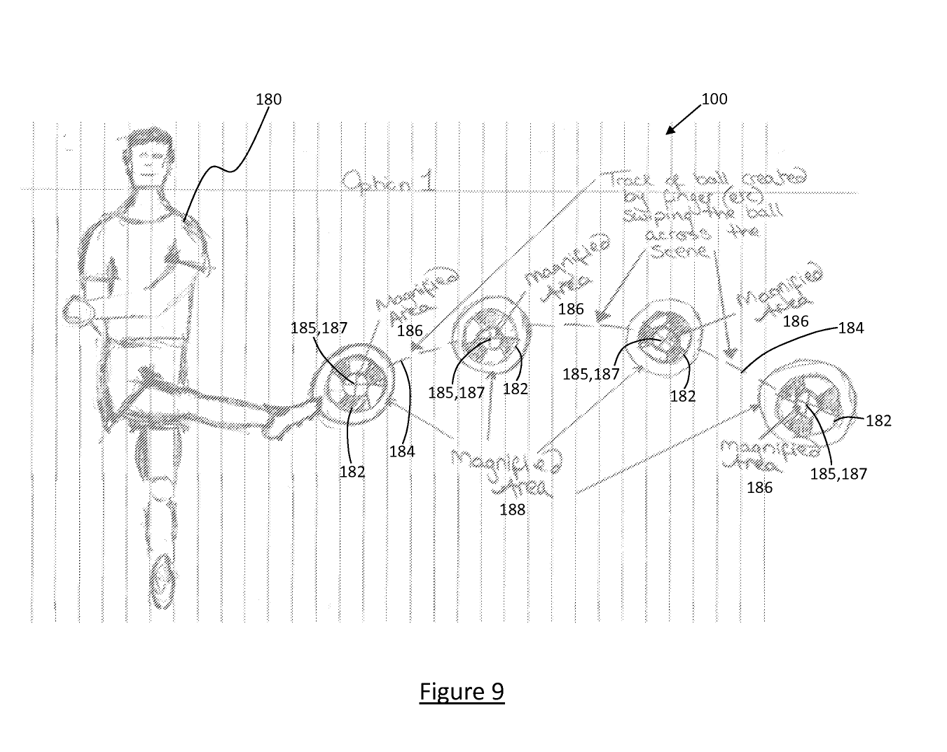

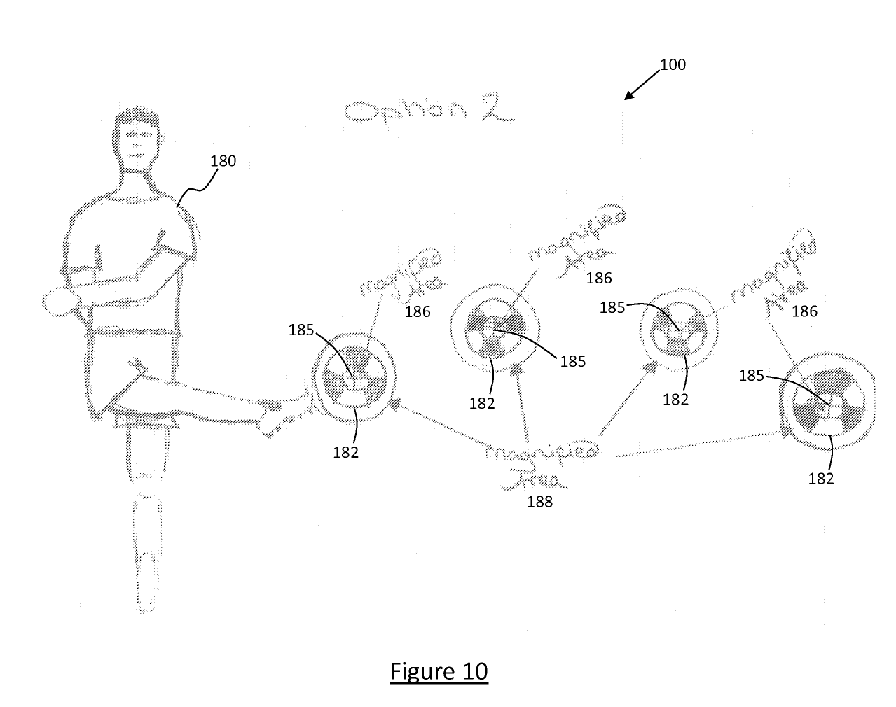

Another embodiment of the present invention also uses the crosshairs 170, 172 described in relation to FIGS. 8a and 8b. In this embodiment, the authentication database 14 stores a series of scene location grid references which correspond to the centre points of the ball/object moving along a path before and/or after the time the scene 100 was captured. The ball and the path information has been removed from the scene 100 which is presented to the player and the player then has to recreate an average path of the ball 138, 142, 158, e.g. a moving path of the ball (an arc), on the screen 24, 132 using their skill and judgement (example shown in FIG. 9—described later). This path creation can be used in two ways namely for an instant win or for a future draw. With the instant basis, the authentication server 10 can reference the authentication database 14 to compare the player defined path of the ball with the stored actual positions of the ball along the path. The player who's path entry is closest to or matching these stored points is the winner either on a draw or instant-win basis. More specifically, for an instant-win game, the winner is determined if their entry is within according to a known tolerance of the actual path, so that the ball path drawn by the player could be fractionally out but still result in a winning entry (if it is within the known tolerances). Alternatively, with a future draw competition, the closest set of player-selected path mapping grid reference points to the real path of the ball would be the winner from all of the entries over a known period of time.

It is also possible to have data entry into the game in this manner for physical game cards 23. However, when using both physical and electronic game cards for the same game (namely the same scene 100 is being presented on both medium), a problem can arise in how to reconcile gaming entries on both mediums (namely on paper and on the screen). On paper the player would draw a path (arc) and at least a certain number of “hit” points have to concur, namely to match the balls path (for example three matches on a ball's real path). The player with the greatest number of hit points would win a prize. In an electronic version of the game, the player can be notified that they are within a predetermined region of the correct location for each point of the path (arc). The terminal can also provide a small number of correct hit points along part of the path of the ball (assisting the player with their location selection) which also further allows the player to refine their ball arc. On paper, the player can draw their entry which is scanned at the terminal and the terminal prints out (or burns out with a laser) the player-selected hit points of the arc 162.

In another embodiment, the ball/object which the player places into the scene 100 to estimate the position of the removed ball/object can be provided with a luminescent tail rather like a comet tail so as to help the player mark its path of movement. The luminescent tail can remain on screen 24, 132 for a while after the ball/object has been dragged across the screen 24, 132. In this embodiment the ball/object not only has an exact position at the time the scene 100 was captured, but can have a starting point and an ending point defining a path (arc) of travel of the ball/object from the time of the scene into the future. This future estimation of the movement of the ball/object provides an additional competition for the player in addition to the correct location of the ball at the time of the scene 100. In an alternative embodiment, it is also possible for the player-marked path to be a path leading up to the time that the scene 100 was captured, namely a past path. In a further embodiment, both a future path and a past path can be required of the player for the further competition.

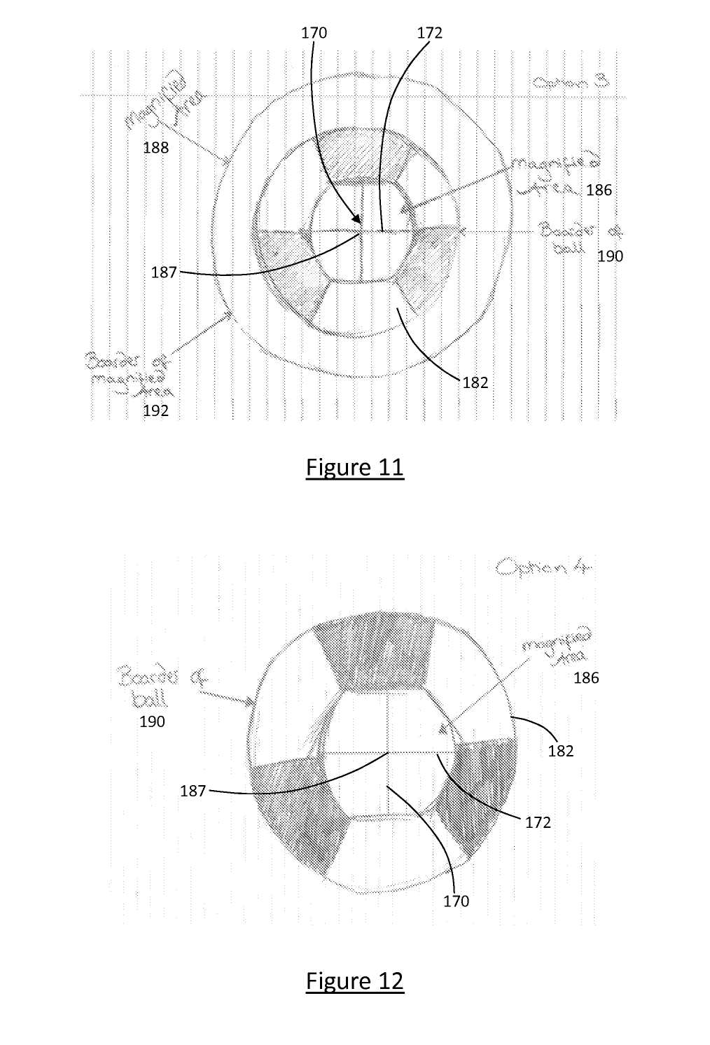

Referring now to FIG. 9, an additional feature which can be applied to any of the virtual game card embodiments described herein is now described. FIG. 9 shows a scene 100 displayed on a virtual game card 130. The scene 100 comprises a football player 180 kicking a ball. In the scene 100, the actual ball will be hidden as will the actual path the ball takes after it has been kicked. The player then using their skill and judgement not only selects the position of the missing ball using a ball representation 182 at the time of the scene 100 but also traces out the path 184 of the ball representation 182 after it is kicked. This is represented by a dotted line 184 provided between several locations 185 of the ball representation 182 over time as is clearly shown in FIG. 9. In an alternative embodiment shown in FIG. 10, the scene is exactly the same as that shown in FIG. 9, except that it is not necessary for the player to define the path 184 explicitly on the scene 100. Rather, the discrete positions 185 of the ball representation 182 at certain intervals are simply selected by the player and the path 184, whilst not explicitly shown in the scene 100, is extrapolated between these positions 185 by the authentication server 10 once the electronic game card 130 has been submitted. The specific position of the ball representation 182 is defined by a marked centre 187 of the ball representation 182.

Referring now to FIG. 11 the ball representation 182 used in the embodiments described above is further described. The ball representation 182 is specifically designed to assist the player locate the position of the ball representation 182 as accurately as possible. More specifically the ball representation 182 is formed of a circle or other form of border 190 and the marked centre 187. The marked centre 187 is transparent such that the ball representation 182 is in the form of a ring (scene-obscuring portion). Accordingly, when the player drags the ball representation 182 it over the scene 100 he/she can still see at least some of the scene 100 underneath the ball representation 182 allowing them to more accurately trace the ball's path because the ball representation 182 does not completely obscure the scene 100 underneath it. Each ball representation 182 is provided with two magnified areas: a central magnified area 186 and an outer ring of magnification 188. The central magnified area 186 is provided to help accurately locate the specific point at which the ball representation 182 will be placed by the player. A vertical crosshair 170 and a horizontal crosshair 172 are provided which in turn define the marked centre 187. The outer ring of magnification 188 is provided to magnify the general location in which the ball representation 182 is to be placed. The outer ring of magnification extends from the border 190 of the ball representation 182 to a greater diameter border which acts as the border of the outer ring of magnification 192.

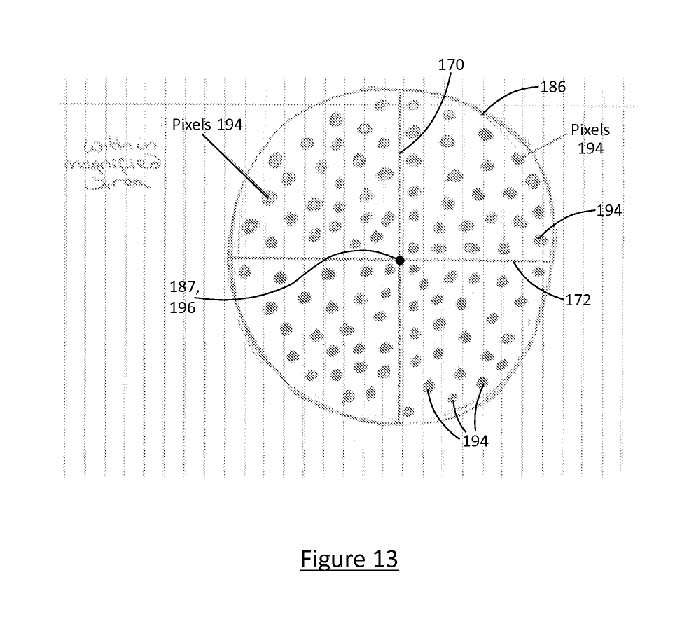

In FIG. 12 an alternative ball representation 182 is shown. The ball representation 182 is identical to that shown and described above with reference to FIG. 11, except for that fact that the outer ring of magnification 188 is not provided.

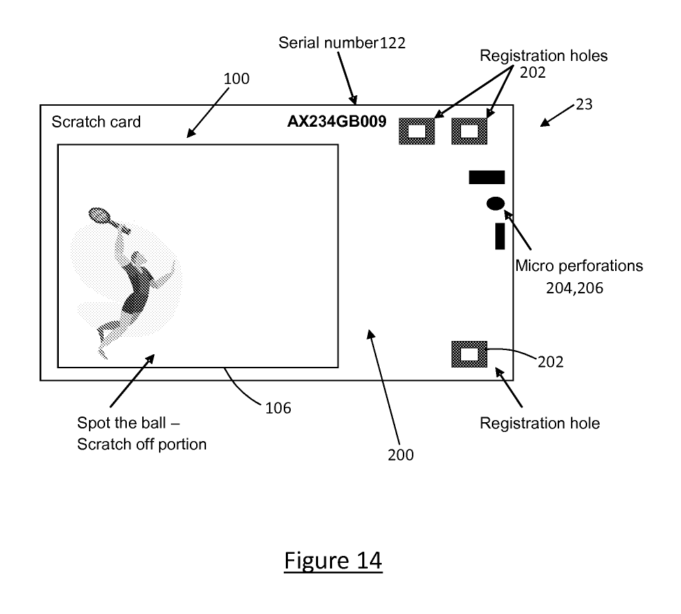

In the above embodiments, when dragging the ball representation 182 across a scene of a virtual game card 130, the ball representation 182 can provide a magnified space within and around the ball representation (FIG. 11) or just within the ball representation (FIG. 12). By magnifying the space at least within the ball representation 182, this allows the exact pixel which may be picked by the player to be displayed in great detail. FIG. 13 shows the central magnified area 186 in greater detail. Here the pixels 194 which make up the scene 100 are visible and the player can manipulate the ball representation to position the marked centre 187 over the actual pixel 196 which marks the selected location. This level of magnification around and through the exact marked centre 187 of the ball representation 182 magnifies the pixels 194 underneath and provides a much higher degree of accuracy not only for dropping into an exact chosen position relative to the exact position of a pixel 194 but also for creating an exact path 184 through a scene 100 if required. This centre magnification embodiment can also apply to the embodiment shown in FIGS. 8a and 8b, where the crosshairs 170, 172 are dragged by the player touching the end of the crosshairs 170, 172 at any of grip points of the crosshairs 170, 172.

It is also possible in another embodiment for there to be a user-selected option to zoom into the scene of a virtual game card. This zoom-in function can be very useful as is the case with the magnification function described above, because it enables the player to very carefully select the exact location in which the determination of the missing object is to be made.

In another embodiment, the scene 100 to be marked by the player can be formed to be part of a phone top-up card (not shown) (which can include printed thermographic or other form of paper) sold by a retailer under secure conditions for such phone top-up cards. In this case, the mobile phone top-up card would have its conventional top-up access code (usually visible by scratching off a protective coating) and a two-dimensional scene 100 which has a portion relating to a movable object removed from the scene 100. The top-up card would also be provided with a pair of grid reference axes 118, 120 which would enable the player to specify a grid reference 115 to a location 116 within the scene where the player considers that the missing object is located. The grid reference 115 could typically be a simple alphanumeric position identifier such as ‘A8’ (see below). This position identifier 115 would then be appended to the top-up access code and sent to an authentication server when the access code was being used to top-up the air-time credit for the mobile device 46. In some cases, the top-up card is printed on the terminal at the vendor using an automated or non-automated process by an ATM/manned terminal/unmanned terminal/POS terminal with the code and relevant scene 100 of a phone top-up card. The term ‘top-up card’ as described herein includes printed, thermographic or other forms of paper.

As has been mentioned above, the printed scene 100 on the top-up card in this embodiment includes grid references 118, 120 at its sides, such that the player on deciding the location of the missing ball, can specify that position by simply quoting the grid references (e.g. using a 1-10 scale on the horizontal axis and an A to Z on the vertical axis such that for example the grid reference ‘A8’ would give an exact square reference). The player can type the top-up code and the grid reference 115 e.g. “A8”, into an SMS message which would then be used as the player's top-up instruction and also an entry into the instant-win game, and then send the SMS message from his/her mobile device 46. The top-up server could simply separate the top-up code from the grid reference 115, determine whether the grid reference for the top-up card specified by the top-up code is within a predefined region of the correct location of the missing object, and if it is then notify the player of the win by sending him/her an SMS message back. The winnings could readily be in the form of an additional top-up credit for that mobile device or provide a code which could be used at any ATM for the player to collect their instant-win.

It is also possible in this embodiment for the top-up card to be printed on demand by payment to a printing terminal. The terminal could readily print a scene 100 on the top-up card in the form that has been described above, and the scene could be selected from one of many pre-stored video frames of for example a sporting event. The scene can also be re-rendered at a different angle before being made available for printing onto the top-up card. This would ensure that even if a film or picture sequence is available of the sporting event, only the authentication server 10 will know the exact ball position which will have changed from the available sequence by virtue of the change of viewing angle of the scene 100. This feature ensures that security is kept relatively high against fraudulent activity.

A unique identifier of the exact frame which is printed (without the missing moving object) is communicated back to the top-up server such that the specific location of the correct answer would be known for that particular selected scene. As the top-up code when submitted by the player will now also refer to a specific known scene, only the authentication server 10 will know the exact position of the missing ball/object for that scene 100. That exact ball/object position e.g. A8 will be within the top-up code so the top-up server need only compare the player's reference of A8 to the correct one (in this case A8 also) to determine if the code reference provided by SMS message, for example, and the correct box reference are the same to result in the top-up card and player location selection being a winning entry.

In another embodiment, the top-up cards are printed on demand. In this case a manufacturer's barcode is scanned into the terminal by the vendor prior to display. A separate code is added on a vendor's database allowing the item to be used for the game display/linkup and notified to the manufacturer/vendor/game database. Then at the POS terminal, the customer is offered the option to purchase the top-up card. If the player takes the option, the relevant code (the same as the vendors code) is activated and printed on the game card (receipt) along with the game depiction if necessary. Then the customer can play/download as has been described above.

In another embodiment, the presentation of a prize in the form of money at an ATM/manned terminal/unmanned terminal/POS terminal can include the subtraction of money from a designated account or pre-paid card. In this embodiment, the unique identifier 112 of the game card which will authenticate that the scene has been purchased, may also be used as a phone top-up code for pay-as-you-go mobile device 46 to be entered into the device in the normal way. In this embodiment, the player's own mobile device (having a camera) can scan the printed scene (as printed by the ATM/manned terminal/unmanned terminal/POS terminal) with the player's own marked location on it, designating the missing object. The code authenticating the scene could also represent an account top-up authentication code such that the central authentication database 14 could authorise the scanned scene and instruct the top-up server to allot extra time (i.e. monetary credits) to the mobile device (if required having subtracted the payment for the marked printed scene if necessary).

Another embodiment is now described, which is a variation of the top-up embodiment described above. In this embodiment, the game card 23 is pre-printed and provided as an integral part of packaging for goods sold via a retailer, for example a cereal packet. As before the game card (now an integrated cereal packet) comprises a scene 100 (for example a sports scene) with an object removed from that scene (such as a ball). A top-up code is printed on the packaging together with a product-identifying barcode. However, in this embodiment the barcode (or a separate code, printed adjacent to or away from the barcode or indeed printed separately on a separate post barcode printing attached label, that references the bar code via an encoded algorithm approach) not only identifies the product, but also includes within it a unique reference for the specific game card (such that each barcode varies for each product sold). This can readily be achieved by either appending say seven digits to the known prior art barcode to identify a product (though in other embodiments different numbers of digits can be used). The additional digits of the identifier (which will each have a corresponding bar in the barcode) are used to uniquely identify this instance of the product incorporating a game card. Alternatively, a code can be provided within the barcode to which an algorithm at the POS is applied to derive the unique reference to the game card, which can even then be printed out and given back to the player if required.

The barcode is used as part of a process to link the specific product/game card to the sale at the POS terminal. The process takes the unique identifier of the product/game card and adds additional information to it about the specific location or vendor of the goods and the time of the purchase. Accordingly, at a POS, acting as a terminal, when the product is scanned for payment, the unique identifier is automatically and simultaneously read by the terminal and the additional information added to it. The terminal then acts to send the unique identifier and additional information to the authentication server 10 and this information can be stored at the authentication server. The authentication server 10 then responds with a real-time value representing a value of a prize fund for that unique identifier. The terminal displays the received real-time value of the prize fund to the purchaser of the goods.

The purchaser can then decide whether they wish to become a player and participate in the game. If they do decide to play, they can pay an additional fee to the vendor, and then the terminal (under operator control), can send a confirmation message back to the authentication server 10 which includes the unique identifier of the just sold goods. The purpose of the confirmation message is to make the alphanumeric code which was printed on the cereal box and which has a counterpart entry in the authentication database 14, live such that it can be used for a subsequent mobile phone account top-up transaction. Where the vendor (or manufacturer) of the goods has paid the additional fee as a promotion then the customer of the goods in agreeing to partake in the promotion causes the fee normally payable by the customer to be charged to the vendor/manufacturer.

Subsequently, the player takes the goods and at any time can play the game in order to provide their best guess at the location of the missing object. Having selected a location in the scene 100 where they consider the missing object to be, the coordinates of the location can be read off graduated axes 118, 120 provided on the sides of the scene 100. The user then either sends the top-up code via an SMS message to the appropriate SMS short code or keys it in to the keypad having dialed an appropriate top-up telephone number, appending the coordinates of the selected location. The top-up receiver checks with the authentication server 10 to determine if that top up code is live and valid, and if so provides the top-up credit to the player's account. The receiver also passes the selected coordinates of the missing object to the authentication server 10 to determine if the selected location is an instant winner. The player can be interrogated at this point regarding the purchase of the goods, to provide security and ensure a stolen goods cannot be used without knowledge stored at the authentication server of the additional information parameters associated with the original purchase (for example the date or store from which the goods were purchased). This prevents the risk of the goods being stolen after the top-up has been paid for but before it has been used. Correct responses to questions asked at this stage can validate the player as the purchaser and can permit a response to the game to be provided. If the player has won they can receive a win code which they can take and enter into either a manner POS terminal or to an unmanned terminal such as an ATM, to claim their prize. This is a secure way of providing the service which prevents fraud.

A variation of the above embodiment is now described. As before, a sports scene with an object removed (a missing object) is pre-printed on a packaging of a goods sold at a POS terminal (such as a supermarket checkout POS terminal). A code (such as a machine-readable barcode) is also provided adjacent the scene 100. A hand scanner (or fixed scanner) scans the barcode and then puts on an individual code beneath the price of the goods, namely this can be part of the normal price printing at the POS terminal that goes on in certain store etc. This can include a label printing which is then attached to the packaging of the goods by the hand scanner/printer. At the checkout, the player has their code activated and can either subsequently use the scene 100 itself printed on the packaging of goods to play a spot-the-missing-ball game and/or have a selected scene downloaded to their computer/mobile phone smartphone/PDA (mobile device) from a particular game/sport that effectively may be semi-unique to them. Thus this embodiment can also be used in conjunction with a virtual game card. The code, printed by hand scanner (either on the goods packaging itself or on a label thence attached to the goods packaging), is unique to the store and combines with the manufacturers code and is thus anti-fraud as the code then is only for purchasers at that store and can only become ‘live’ once paid for at the POS terminal/unmanned terminal/ATM (known to the relevant governing/controlling/central database as located in that store) of that store which is linked to the authentication central server 10. The code is in effect a facility for the customer to buy credits that is linked to both the product (by the scanning of the barcode which is uploaded to a server) and the seller by both the hand-scanner and the code printed under the price. These credits are also linked to the sport/event depicted in the sports/event scene but can also be used to buy credits on a mobile phone system for both phone usage as well as playing the game.

Referring back to the physical game card 23 described with respect to FIGS. 3a to 4c a problem arises (as described above) when the player selects a marked location 116 for the ball representation at a position which is against blocked space 112, namely at a location where a positive image is provided in the scene 100 and that is ‘outside’ white space 114 (where no positive image is provided. This problem is addressed by extending the crosshairs 170, 172 of a given location mark until they extend outside the blocked space 114. Also to assist with the easier reading of the player's marked locations 116 on a scene 100, the figures (in the blocked area 112 of the scene 100) can be provided in lighter colour shades, such that a scanner can detect some degree of difference between the scene and a player's marking (circle/shape and crosshair marking) in that blocked space. However, this is not sufficient in all cases (for example where printing process problems arise which cause erroneous marks to be made on the scene) so a player will be required to extend the crosshairs outside the shape from the blocked region 112 into the white space region 114 on both axes (see FIG. 8a for example). This gives an extra corrective reference for the scan to produce a guide direction. Starting from white space 114 and with the scan processing software assuming a diminishing path starting at the player-drawn line end of the crosshairs 170, 172 in the white space 114, a subset correction can be made for a poorly drawn crosshairs when this is an overlay of a defined non-white space border in the on-demand terminal generated drawing. An example of where the selected object is in white space 114 is seen in FIG. 8b. Also the printing terminal can in this embodiment be the player's own computer as the virtual game card is not live until scanned and paid for. Also if the picture is made of different shaded small squares or circles or other distinct shapes each having a micro-number printed in it, the scanner can by a preponderance of linked crosshairs, distinguish between printing errors, handling damage and a real player-marked location entry.

Another solution to the issue of not being able to recognise player location marks 116 on a scanned game card 23, because of printing errors for example is now described. In one embodiment, a solution is to print the sporting scene 100 in colour or black-and-white either with full filling in of the figures (items within the scene) only (or alternatively only printing their outlines) in the scene 100 with whitespace 114 left in between them. A coded reference (described below), which is also printed on the game card, uniquely references the scene 100 and specifies an outline position on the central authentication database 14 of the sporting scene 100. This outline designates a limitation to area in which the player can create their marked location 116. Upon scanning and uploading of the marked game card to the authentication server 10, the server could choose eliminate all space within the outline as not being available for selection. The server thus reduces the space theoretically available for it to recognise selections by only recognising selections either outside the outlines of the figures and where a selection is made or inside the outline of the figures (assuming herein that the figures have been designated in outline only without filling in) that the only player location selections acceptable for recognition are where there is a single selection within the outlined figure. Thus if two potential user location marks 116 are detected by the scanner within an outline of the figure (defining some of the original blocked space), then this game card is rejected as at most only one mark should be in that outline. Similarly, if the figures have been filled in then only potential user location marks 116 in the white space are available as valid.

In this situation, a secondary problem sometimes arises and relates to registration of the position of the outline of the drawn figures or shapes in the sporting scene 100, such shapes referring to the given information not the eliminated object/ball. This registration for scanning is given by three shapes: two shapes are on one side of the scene 100 and separated by a known distance to give a furthest point for scanning, and one shape on the other side of the scene 100 to give a position relative to the other two shapes. In addition, an outline border similar to a portrait frame border, which has a defined position relative to the three shapes is also printed. These print objects are referred to in the code (this code is the code which is effectively the algorithm verification number attached to the scene and verifying the scene on the central database 14 to which other information can be encoded within the algorithm to be available for decryption and verification by the authentication server 10 and the central authentication database 14. This enables a scanning of the scene to define the outer limit, whilst the outline shapes referred to in the code define the space not available for marking in the player's attempt to determine where the object/ball is.

The player has two available ways to win an instant prize. The first is to place a dot (the player's marking 116) in the whitespace that corresponds with the exact centre of the object or ball which has been removed from the scene. The exact position (location) is held on the central authentication database 14, such that there can be a player future draw process of either the winning point which shall be not subject to any dispute or a selection of the nearest points to the centre if no player has got the exact centre. The player thus marks a dot on the scene corresponding to the exact centre of the estimated location of the ball and places a circle around the dot, corresponding to an outer marker. The outer marker will be required to be within a certain distance of dot such that a random drawn position not corresponding to the centre but designating an instant winner and held on the authentication database 14 will be available. This will mean that upon scanning, a centre for the purpose of the different delineated prize will be available for scanning, and a second prize being for an instant of any dot within a designated area, not corresponding to a centre, can delineate an instant winner.

The technical problem exists of how to take an ordinary scratch card that has been pre-prepared that a centralised security printing side with winning card information and allow this card to be associated at a remote insecure site with generalised prize draw information and possibly specific identity information if it is to be used in conjunction with a financial transaction requiring a KYC (know your client) process.

In addition, the scratch card by its very nature has an element of fragility encumbering any contact printing process and also requiring the printing process to take place at a distance on the card from the scratch card element itself without any contact pressure.

There is also a need for the scratch card to be held in an element allowing for a secure dispensing as well as protecting the card from accidental damage causing a false scratch.

In one of the embodiments described above, a dispensing box 36 is provided which provides some protection of the scratch cards 23 before dispensing. The dispensing box 36 needs to be robust and should ideally be filled to the maximum to maximise space usage. Also the dispensing box 36 only need have an electrical supply as opposed to a telephone and other communications connections to allow for relatively unsupervised access within a retail environment.

The solution is to have scratch cards 23 that have a unique identifier 122 and a plain cardboard area which supports the unique identifier 122 which is linked, on a central authentication server 10 and central authentication database 14, to a book (batch) serial number (not shown) also held on the central authentication database 14. The vendors, upon loading a book (batch) of scratch cards 23 into the dispenser 36, key-in a book serial number (not shown) into the terminal 34 with a communications channel to the authentication server 10 and receives back a specific code (not shown) from the central authentication server 10 and central authentication database 14.

This specific code is an instruction to the dispensing box 36 with regard to the relative positioning of alphanumeric symbols i.e. A-Z and 0 to 9 that would allow the box 36 to have a unique positioning for printing these alphanumeric symbols on the game card 23 such that the unique positioning is a relative positioning only known to the central authentication database 14 in association with the book serial number that itself is tied to the individual unique identifiers 122 and vice versa. Thus the locations of the alphanumerical symbols on the game card 23 are unique to each book of scratch cards 23.

Referring to FIG. 14 the game card 23 has a cardboard area 200 in which has been pre-cut at least three holes 202 of any determined shape (rectangular in this embodiment). These holes 202 allow the penetration of light upon a light-sensitive surface. The holes 202 relate to registration markers for positioning of the laser 40 and establish relative vertical and horizontal positions.

In use the player enters into the terminal 34, self-selected or automatic pick prize draw number information and/or if required the ID information required for a KYC process. The dispensing box 36 has a numerical designation which can be entered on the numerical keypad or has a button release on the individual box. Upon the right code being entered or the button release being pressed, the game card 23 is dispensed from a slot in an ordinary dispensing fashion of such dispensing boxes 36. During this transition, the card 23 crosses a light-sensitive surface where light is shone at the game card 23. The light allows the game card to be positioned and the laser 40 to burn a series of holes 204 at positions relative to the three pre-cut registration holes 202 and corresponding to the individualised specific code for that particular series (book) of game cards 23. These series of holes 204 are machine-readable but the locations have no meaning to the human eye. Alternatively, the holes 204 can be in the form of micro-perforations 206 which also are machine-readable, but only interpretable with information available at the authentication server 10. In addition, the draw numbers and included references (not shown), as for an ordinary lottery ticket, can be burned into the game card 23 on the cardboard portion 200.

In addition, the dispensing box 36 can have a symbol keypad to generate symbols as described in our co-pending International patent application WO 2010/086827 to allow for symbol information to also be placed on the game card 23 by means of burning a hole or holes in particular positions. The relative position of the holes 204 to the pre-cut holes 202 is determined by the code entry into the dispensing box 36, where the code entry is related to the book serial number and the individual card serial number 122 on the central authentication database 14.

This scratch card 23, which has been now loaded with relevant information by contactless printing process that cannot damage the scratch card area 106, is available for scanning on the authentication server-connected terminal 34 to designate the unique identifier 122 as live. The scratch card portion 106 does not have to enter the scanner 38 for scanning but rather only the portion of the game card 23 carrying the holes 202, 204 that have been formed thereon, thus further protecting the sensitive scratch card portion 106 of the game card 23.

The game card by definition would need to be relatively small to fit in to the average dispensing system as well as be produced by the average scratch card security printing system. This would leave very little room for other forms of contactless printing which would in turn have difficulty in registration of the printing in such a way that information could be random and held by the dispensing box 36 without risk of it being hacked. The present embodiment does not suffer from this problem.

A hacker of the dispensing box 36 would only get useless information as to alphanumeric encoding relative to a serial number, wherein only the central authentication database 10 would be able to translate the meaning of the positioning of the holes into letters or numbers or symbols.

As has been highlighted above, in an embodiment scanning of the scratch-off portion 106 of the scratch card 23 is carried out. The whole area 106 is scanned to ensure that no portions have been scratched off either inadvertently during the distribution process or deliberately by a fraudulent player. This is possible due to the reflective property of the scratch-off surface. If the scratch card portion 106 is intact, a portion of the scratch card 23 (cardboard portion) which has an exposed part as shown in FIG. 14, is accessed by the scanner 38 and the registration holes 202 are located. Then the serial number 122 is read and sent to the central authentication server 10 and, if authenticated, a confirmatory unique authentication code is returned. This authentication code is then used to control the low-cost laser element 40 to burn features into the scratch card 23 which confirm its authenticity. For example, as has been mentioned above, the features could be a representation of the authentication code 204, or machine-readable micro-perforations 206. Alternatively, notches can be burnt into the edge of the scratch card 23 to represent the authentication code.

At any time the physical feature of the machine-readable burnt holes 204 or formations created by the laser element 40 can be read by the scanner 38 and the terminal 34 and used to confirm the authenticity of the scratch card 23. The manner in which the laser element 40 operates is now described.

The laser element 40 is typically based on a low-cost relatively low-power laser diode. The module preferably is designed to be low-cost and can be retrofitted to existing scratch card dispensing and authentication terminals and has the ability to enable encoding allowing for the laser 40 to burn individual holes 202, 204, 206 in the scratch card substrate. The power of the laser 40 need not be great as the distance that the laser energy has to travel to effect creation of the burn-through formations is small. However, there needs to be sufficient energy to enable the thin substrate of the scratch card 23 to be physically and irreversibly altered (burnt).

Rather than physically moving the laser diode 40 in order to control the shape and location of the physically-altered formations in the scratch card substrate, a glass laser-impermeable filter could be provided, wherein the filter would be electronically altered to allow the laser light to penetrate in the relevant areas as per the encoding and as has been described in International patent application WO2011/161661. Other techniques can also be used to reduce the cost of the laser-diode 40 and to provide for configuration of the shape of the burn-through formation to be created in the scratch card 23.

Returning now to the virtual game card embodiments, as has been briefly mentioned above, mobile devices have a further problem in that not all devices have a touch screen. Even ones that do may still need fine adjustment for selection of locations. In this case, embodiments of the present invention may use the various screen and non-screen buttons/controls of the mobile device to permit a cursor in the shape of a target site, crosshairs or other targeting object, to be moved to an exact position i.e. right, left, up, down with the cursor moving by exact steps. The code generated for this location entry at the relevant player-selected ball drop/ball centre, can also be adapted to include a device communication address (IMEI number of a smart phone), physical location information (as otherwise there can be conflict/eligibility issues), a scene identifier, and also a position on screen.

If the game card or virtual game card also includes an investment certificate of some kind, then the relevant identification numbers of the certificate can be added to the gaming entry as in a buy one certificate get one free entry. Also when the player buys a good or service, they can add to the security/mitigate against fraud or theft or other unauthorised use by entering the dealer's/vendor's promotion/ID code to get an official entry. Thereafter, a transaction code generated by the authentication server 10 and returned to the player can also contain an algorithmic reference to this promotion/ID code.

This is a further way of solving the problem of how to combine entries across several different entry methods e.g. mobile phone, scratch card etc. while maintaining security of the game card at the same time.

In addition, the mobile communications device 46, 48 or fixed terminal 18 with a video screen 24 can request a download of a video/or other form of moving picture sequence and, at any point in the media sequence, a relevant button or actuator can be activated by the player and a routine in the application (app) can selected a frame of the moving picture sequence. At this point, the graduated axes 118, 120 can be provided and the player can select where they think the missing ball is positioned. The player then can submit the virtual game card entry in the case of a mobile communications device either via the app 49 or by SMS message from the mobile device 46, 48.

In another embodiment, a standardised grid line with sufficient divisions to mark the exact position of the pixel may also be used to address the problem that different mobile devices (e.g. smartphones) may have different pixel densities making it problematic to agree the exact pixel (location) which at the centre of a disguised/removed object in a picture or a moving sequence of pictures. Under this embodiment, a given smartphone for example may not be able to identify the exact centre as compared to a smartphone with denser pixel presentation ability, but can make finite placements “within” a pixel by resorting to finite adjustments relative to the standardised grid line. Extended crosshairs whose intersection lines would give the exact address could allow for a comparison across the different pixel densities of smartphones.

In another virtual game card embodiment, a variant is to require the correct ball location prediction in more than one picture or in more than one scene in a moving sequence of relevant scenes on a mobile device or a terminal with a display. Also on either the terminal or mobile device implementations, it is possible in an embodiment to get a “build-up” opportunity, namely it is possible to select a moving sequence of scenes with the ball now no longer in it. By selecting a button, a sequence of scenes is split into a series of still pictures i.e. the moving picture sequence is split into its underlying single images and the player then has to ‘spot-the-ball’ in each of these single pictures from the series of pictures. Then the program reassembles the scenes and creates a “ball track” a path of the moving ball. If any of the players entries are on the actual track of the ball over these frames or the closest to the actual track then they win the game.

In the above, either for a lottery or a prize associated with an investment or banking instrument of some kind, the selection of the correct centre of the ball (or otherwise indicated position of the ball) position will be the winner. The authentication server 10 has an algorithm enabling it to calculate the path of the ball that would allow it to determine either or both the path of the object and its centre for any given “freeze-frame”.

Upon selection, the applicant initiates contact with the authentication server 10 via the unmanned terminal and either an instant prize can be won or there is a draw at a defined period and the exact or closest to exact position wins the draw.

Also, in another embodiment, in addition to implementing a ‘Spot-the-ball’ game, a video (sequence of scenes) is made available on a wide-area network attached to the authentication server 10. In this embodiment scenes 100 with requisite details can be printed off as transaction slips with all of the described details, for example with several squares to be filled in, paid for and scanned into one of the scanner terminals. The video is made available on the web and selected scenes are then printable by the player using home computers and their printers.

In addition, in the embodiments described above the mobile phone app 49 can receive updating information about potentially varying prize amounts relating to any virtual game card 130. This can be particularly important when the prize size is related to any set of game cards is governed by a fixed or variable association with sales volume. In an alternate embodiment, prior to the player purchasing a virtual game card 130, the player can see the relevant prize size and/or rising instant prize sizes (which increase as a function of number of non-winning entries recorded over a period of time) within a real time or near real-time time window.

A potential problem with the mobile device 48 and the app 49 provided thereon is that the general authorities (for example Apple) controlling and governing the operation may require a 30% or more charge for “purchases” within the app. This can be prohibitively expensive. Offering a virtual game card as a purchase outside the app 49 may offer a business solution to this issue. However, this in turn may raise the issue of low security which arises. The present embodiments can overcome this issue by allowing downloads etc. only to players a registered via the app 49. Another embodiment offers a technical solution of linking the allowability of a given download of a virtual game card without making it an “In App Purchase”. In this embodiment, the app 49 has a particular unique identifier code created during registration via an algorithm. The algorithm provided in the app 49, links together data describing the SIM and the smartphone and the unique identifier code and creates the unique purchase identifier. The unique purchase identifier is then registered on the central device database 12 against pre-registered financial details. This enables any purchases that occur outside the app 49 to reference that financial data and retain a relatively high degree of security because the virtual game card which is downloaded has a unique access code specific to the app 49 provided with it so that only that particular individualised app 49 can read it. Thus the request would only be uploading the app unique purchase identifier which would be effectively outside the app and on download only receiving the unique access code. Purchases would be received outside the app, but viewed within it.

In another embodiment, the game card 23 can be offered to purchaser of a lottery ticket or potentially any other product to which the game card 23 is attached as a promotion or a sales item. The POS terminal operator offers the player the game card 23 regarding a spot-the-ball option which is playing on visual display unit 24 of the POS terminal 18. If so, the operator takes an extra payment and a game card 23 prints out at a print station away from the crowded POS terminal 18. A key feature is that the terminal 18 is configured by a local algorithm (carrying out function ƒ) to generate game card unique identifier (y) linked to the transaction number (x) on the lottery ticket/investment certificate (namely y=ƒ(x)). In use the player fills out the spot-the-ball game card 23 as described above and then puts the game card 23 together with their lottery ticket/investment certificate through an unmanned scanner 22. This information is scanned and uploaded to the authentication server 10 which verifies that the game card 23 has been paid for by comparing the transaction number (x) on the lottery ticket with the result of the (re-algorithmed−ƒ′) game card identifier (namely ƒ′(y)=x). The print station can advantageously be located quite far away from the POS terminal 18 which enables a retailer to utilise dead space in their retail environment. Also it could involve sending the picture to the player's mobile device 46, 48 and sending an SMS message including a new game card identifier (y) associated with the lottery ticket/investment certificate or the transaction number (x) on the lottery ticket/investment certificate.

In another embodiment, the player will, as has been described above, enter into the SMS message or phone app 49, the card serial number 122 and the alphanumeric code 107 relevant to the scratched-off position 108 of the game playing area 100, where the player thinks the ball is and then the larger displayed symbol/number 126 underlying the game playing area 100. In addition, after the player scratches off the layer on which the alphanumeric code 107 relevant to the position of the ball was displayed, the player will also enter a code (which can be changed from time to time) which will be unique to the retailer and given to him by the central authentication system 10, 12, 14. This code can be player-specific and generated by the central authentication system 10, 12, 14 and sent to the retailer's terminal 18, 26, 34 to allow the retailer to take payment before supplying the game card 23. Alternatively it can be retailer displayed (both to allow the retailer to be credited if payment is made via the mobile phone and also to allow the central system 10, 12, 14 to certify that the game card 23 with that serial number 122 and other identifiers was supplied to that retailer).

In an alternative embodiment, both the virtual scratch card 130 and the physical scratch card 23 can be provided with a hint or clue functionality. This means that the game card 23 cannot be used without going through the terminal. When the physical game card 23 is passed through the terminal 34, the low-cost laser 40 of the terminal 34 ablates a few areas on the scene 100 where the ball was not provided. Alternatively, the terminal 26 can quickly and simply ink overprint areas of the game card 23 with squares rather like pixel distortion squares on a video during transition from one picture to the next. This indicates areas where the missing ball is not to be found. However, for both the virtual scratch card 130 and the physical scratch card 23 some of those areas would be specific to the game card with that unique serial number 122. If this was copied by hand to a different game card 23 or if there was an attempt to use that video sequence with a different reference, then this would show up when presented for claim by the central authentication system 10, 12, 14 which would have associated those ablated or inked-over areas with the individual serial/reference number 122.

In the virtual game card 130 on any device embodiment, a unique blackout stamp could be created on request by link from the terminal 42, 48 to the central system 10, 12, 14 which again would cause specific areas to be blocked out of the sequence of video scenes 100 displayed. Since the sequence of video frames of the same event can be filmed from a multiple of angles, such that minute differences can arise, numerous numbers of video sequences can be produced of one event. This then enables the game to be either a spot-the-ball moment in a freeze frame during a video sequence or a track-the-ball-movement and/or spot-the-end-position of the ball during the moving video sequence, both as have been described previously. Accordingly, numerous numbers of different video frame sequences of the same event can be offered and thus numerous numbers of individualised video frame sequences to be generated, where it is not “black” pixel blocking out for the virtual game card 130. In this way the virtual game card 130 with minute difference video frame sequences of the same event can be linked to the minute differences in printed game cards 23 for the same event. Each game card 23 is open for individualised block out providing clues to the player of where the ball is not provided. This can be either by black pixilation for a minute amount of time before the player makes his position pick (after which as an option black pixilation can be made to disappear on the virtual game card 130) or by laser burn out or by ink block print over for the physical game card 23 at the POS terminal 26, 34.

This not only offers the player an interesting helpful clue, but it also stops non-authorised game cards from being used as the game card 23. This allows the distribution of game cards 23 to be made under low control as they are not live until presented at the terminal 26, 34, and the overprint or laser burn carried out. With the game card, the scanner 22, 32, 38 can then simply check if the correct ball position has then been scratched off before presentation for payment to the POS terminal 18, 26, 34. This is achieved by a simple two-layer printing and the layer with the ball having a machine-readable ink and the layer for scratching off not having this ink. If the ink is revealed already, this indicates that the card is invalid. Also a relevant game card will have events of the scene 100 ink overprinted/burned off at the terminal 26, 34.

Thus this embodiment provides a physical game card 23 having a minimum two-layer solution with a machine-readable under layer so as to allow the terminal 26, 34 to check for each game card purchase if there had been any invalidating attempts to scratch the game card 23 and find the winning position.

In another embodiment, the terminal with a video display 24 can be used to display the scene and the game card 23 can be a re-usable grid for recording the player's best estimate for the location of the object which is missing from the displayed scene. In this regard, the displayed scene 100 would have a grid reference arrangement which could be the graduated axes 118, 120 of previous embodiments. The same grid references would be provided on the reusable game card 23. Once the scene had been displayed on the screen, the player could simply mark the grid of the game card 23 and have this read by the terminal—either by way of scanner or some other grid reference reader. The entered grid reference can be used to determine if the location is an instant-win location by the terminal sending a request to the authentication server 10 to confirm whether the selected location on the grid references is close enough to the actual location to result in an instant prize being awarded.

In another embodiment for the virtual game card using a mobile device, an image is captured and then a pixel reference is determined of the location of the ball and this is recorded as a grid reference. The grid reference is a unique vertical and horizontal reference, where the scale-defined horizontal and verticals references are derived by an algorithmic treatment of certain fixed values unique to the players' electronic device, e.g. the player's SIM card and/or their phone/PDA/computer or their Internet address. The problem which this embodiment addresses is how to take a picture of a moving object, upload it and then have the replacement of the location of the ball made unique to the player's device 46, 48 so that others cannot use knowledge of that exact pixel location for a spot-the-ball game on another device.

In picking individual scenes to get right on the mobile device 46, 48 there is a secondary game available. This game consists of picking a series of scenes 100, the scenes 100 being displayed, moving the scenes 100 displayed as shapes into an order, pressing a lock button and sending the uploaded picture which is a pallet of scenes 100 to the central authentication server 10 to register your vote. Whichever player matches the highest number of votes wins the game.

The innovation is in the device providing the player his picked scenes as a pallet and then enabling him/her to shift them according to the player's prediction of popularity of the scenes and to “lock” them for one individual payment and then unlock them and reorder again for another payment. Also as the ball position is picked in every scene 100, two games are played simultaneously: namely spot-the-ball as described above and also predict amongst a group of players which will be the most popular scene 100 picked and placing all this in order.

In another embodiment, the mobile device 46, 48 is configured to enable the player to draw on the scene 100 generated by the mobile device 46, 48 in the same way as the player can draw on a piece of paper. This unifies printed and virtual electronic scenes 100, namely with graduated axes 118, 120 and a circle target with extended lines 170, 172. In the virtual game card case there is a difference in that an algorithm now draws the player's line using corrective technology so that the electronic line is the straightest line that can stay within the bounds of the hand drawn line, namely not go outside the hand-drawn area. This produces an electronic drawn target, i.e. crosshairs 170, 172 which the player then gets to agree to or vary by putting a finger or stylus on it and moving it. Alternatively, the player can agree it is correct and this becomes his entry into the spot-the-ball competition. Also instead of leaving his entry as a pair of crosshairs 170, 172, the entry can be transformed into a uniform ball. With this ball, the electronic crosshairs 170, 172, created by the algorithm from the player drawn ball on the scene on his screen 24, 132, would designate the exact centre which is the item required to decide the winner.

Also the device 46, 48 can be configured to allow the player to draw a ball on the scene 100 and this will be transformed by the app 49 on the mobile device 46, 48 or terminal display 24 into a marked location 116 entry on the virtual game card 130. This way of specifying the location of the marked entry thereby avoids the problem of the location of the ball as determined by the hand-drawn ball being open to interpretation. In the same way as the crosshairs 170, 172 are transformed into a ball, this hand-drawn entry also is transformed into a ball and the player can agree to it or shift it as desired before accepting its location as entry into the competition.

A further variation is provided in an embodiment where the player is required to predict a correct ball location in more than one scene 100 or in more than one frame in a moving sequence of relevant frames on the mobile device 46, 48 or the terminal video screen 24 is now described. The player is presented with the sequence of frames at the terminal screen 24 in a store, via a website, online or on the screen 132 of the mobile device 46, 48, e.g. a smartphone, tablet or other suitable communications device.

A player is shown a sequence of frames, e.g. a film/video clip, which contains a moving object. In a first example, the player is shown an “unmodified” sequence in which the moving object is visible throughout the sequence of frames. In a second example, the player is shown a “modified” sequence in which the moving object has already been removed. The player is then be presented with an option to “spot the object” in a number of frames from the complete sequence of frames. The “spot the object” game may be associated with a prize that is dependent on the number of players participating in the game.

The complete sequence of frames may comprise a large number of total frames. For example, for a 30-second clip of film, at 24-frames per second, there will be in the region of 720 image frames. Higher or lower frame rates and longer or shorter image sequences may increase or decrease the total number of frames available.

The player may be presented with an option to play the game in one or more frames selected from the complete sequence of image frames. As an example, the player may be given the option of playing the game using a single frame or any number of multiple frames. In the example discussed below the player has selected to play the game using 10 frames. It is to be appreciated, however, that the player may select to play using different numbers of frames. The player may be allowed to select the number of frames he wishes to play the game using or in an alternative the system providing the game may present the player with a number of options (e.g. play the game with “1”, “5”, “10”, “20”, “50” frames).

Once the player has selected the number of frames he wishes to play, the system/program providing the game may select that number of frames from the complete sequence. In this manner, the player has control over the number of image frames he may interact with but the choice of the particular frames that he is presented with is controlled by the game system/program and not the player.

The system/program may then either select the frames for the player (if frames without the object present are already available) or may create frames from the complete sequence in which the moving object is removed prior to be sent to the player.

The player, upon receiving his requested number of frames, may then guess and mark the position of the moving object (as described by any of the above methods). The player may be able to win the game by a number of outcomes. For example, if the player has selected to receive 10 image frames and he matches the object location correctly in one of those frames, he may win a prize. Similarly, if the player matches the object location correctly in multiple frames then he may win a prize for each correct guess.

In addition, by selecting the object location in a number of image frames, the player is essentially defining a “track” for the moving object. The program may comprise a method of determining a “player defined” object track from the player provided object positions. This “player defined” object track may then be compared with the actual object track that may be stored and accessible by the program.

The player with the closest matching object track may win a further prize. The player may also be able to win an “object track” prize on the basis of how many object positions he has correctly guessed out of his total selection. For example, where the player has selected 10 image frames, if he correctly guesses the object position in 7 of those image frames he may win a prize on the basis of correctly guessing the location in 70% of his image frames. In this manner he may win a prize over another player who has correctly guessed 8 positions out of a selection of 20 images (40% guess rate). Thus a threshold percentage may be applied to determine a winning entry into the game.

The game may be played within a “community” of participating players and may also be limited in time. For example, the game may be active for a set period and the player with the closest object track during that passage of active play may win the prize. The game may then be reset or repeat.

In addition, on picking an individual position in a given scene 100 or sequence of scenes 100 for a movable object, then the relevant pixel number, or theoretic number when using a standardised grid reference, could be used via an algorithm to produce a matrix of random draw numbers capable of being entered into a prize draw. The association of the pixel reference, the scene unique identifier (game card identifier 122), the relevant unique mobile device identifiers, the unique app number and the draw numbers would allow for the requisite security to establish after a prize draw for a presented winning draw number that the draw number was genuinely created prior to the draw thus removing one of the fraud risks allowing entry via a given mobile device belonging to a non-secure person.

In another variant to the above described embodiment, it is possible for a player to look at an internet site or other form of electronic display or to walk up to a cash or POS terminal and see a video frame sequence playing on a display 24 with the object moving within the video frame sequence. In this embodiment, the value of the prize is a reflection of however many people are playing the game and is possible to be determined because all of the terminals are connectable together via a wide area network such as the internet, or be determined because an algorithm has determined/calculated the prize amount based on actual numbers of participators. These can be either in amounts of actual payments made by the players to participate or by reference to a form of digital cash paid by a third party paying for the “attention” time of the participants or their exposure to advertising. In this incarnation the pixel number and other unique numbers, including the SIM number, the unique phone identifier, the picture frame number and other unique identifiers would be rendered by concealed algorithm into a unique identifier that could be used not only as security limiter but also as a unique identifier should an financial instrument of some description be provide for linked purchase with the game.

As regards provision of a given sequence or frame of a sequence or individual frame, the terminal is connected to the internet or an intranet and can simply download the video, individual frame (according to the selection of the player as to which of their devices they want it downloaded to), or sequence in the form of a programme (acting as a gaming module) and a referenced sequence. The terminal 18 can be configured to display the frames on the display 24 the player has bought and enables the player to pick the moving object position in those frames under the control of a gaming module. Also or alternatively the selected frames can be downloaded onto the player's mobile device 46, 48 via a variety of connectors/connections including for example a wireless Near Field Communications (NFC) connection from the terminal to the device.

The gaming module which generates the frames for display on the screen 24, 132, is arranged to enable the player to select a pixel from a grid of pixels which make up the frame. If a pixel itself doesn't have a unique number it can be assigned a unique number by overlaying of a grid with numbering references that can give both a unique pixel reference within the frame and also it can be set as a unique global reference with inclusion of the frame identifier itself. The creation of a unique frame reference can be used to create a prize associated with the unique frame identifier and/or associated number. The selection of the frame and/or number can itself trigger a prize before or after the pixel selection within a frame. The prize is associated with the specific frame and/or number by means of prize draws.

Each pixel has two values associated with it. These values can be in one embodiment determined from an aggregation of the selections which have been made on other VDU terminals where the game is being played. The aggregation is carried out at a central server which takes all of the grid references that have been selected and thus creates a player selection map of the pixels (regardless of the location of the object). The player selection map enables odds to be determined for future player selection of that pixel and for the type of selection to be made. More specifically, a view of a specific pixel enables the player to see the odds for and the odds against selection of that pixel. Where a pixel has been selected by many players, its odds for selection are short and its odds for non-selection are long. Similarly, where a pixel has not been selected by hardly any players its odds for selection are long and its odds for non-selection are short. The player can then determine a bet value (entered into the terminal 18 or the mobile device 46, 48) to be placed on that pixel and the outcome. The bet value is then multiplied by the odds for that bet to determine the value of the prize if the player is correct. This provision of odds values to each pixel enables the player to effectively ‘buy’ pixels.

The gaming model thus allows players to determine the odds on a certain pixel and to trade the pixel (buying it or selling it) by means of a market place. This is a concept where players betting for or against an outcome of a pixel are participants in the market as opposed to facilitators of the market (bookmakers).

In a variation of the above described pixel purchasing, the gaming module in software can as an extra element require the player to agree to place a bet then allow them to pick which way (object present or proximate/object not present or not proximate) and in relation to which pixels in the frame. This has the beneficial effect of dissuading players from ‘shopping for the best pixel according to the market’ because of the charge associate with this. Accordingly, it is only possible to see the values associated with a pixel once the player has entered a bet/wager.

The linking of a pixel to the two values also requires the pixel number (identity if the pixel) to be concealed from the player on the screen so the odds are only visible when the pixel has been picked. Under this embodiment the pixel is given an odds number according to how many people pick it and the market place simply buys (bets for) or sells (bets against) the relevant exact odds number and that leads to the bet being put on a particular pixel.

In another embodiment, a player loads one/two or more pieces of film (video) from which it is possible for a computer program to artificially produce a clip of the same film as if it was filmed from a different angle than any shown in the uploaded clip(s). The player films a moving object in one clip and in another the same scene in terms of location again without the moving object, i.e. a football pitch as a ball travels though the air and a pitch without the ball traveling. The two clips allow the computer to simulate a third artificial scene (due to the minute differences in angles between two clips) with a ball traveling across the pitch, but as it is now simulated from a different angle, not even the player who uploaded the scene can know exactly where the ball is.

In another embodiment, to aid the process, because there may be several moving objects at different relative speeds, the player will ‘mark’ the moving object. Firstly, the player takes a clip of a scene running it through software on his mobile device. Then he marks the moving object by picking a still image or images and then ‘marking’ the moving object with a cursor or crosshairs.

In addition, in the case of uneven (mostly non-spherical) moving objects designating the centre is not indisputable, hence the potential not to allow ‘spot the flying fish’ clips for example. To avoid this problem, the authentication server recalculates the area displaced by the object in any given still shot from the clip and then this is redistributed into a designated regular shape. In other words where the object is not regular it is plotted (laid over a grid) and “redistributed” into a regular shape and a centre drawn either by diameter or if it has corners then by bisecting via the corners and drawing lines creating the centre. This allows for a bisection of the object by drawing its diameter lines or intersecting lines, starting in corners is to get a best fit. The idea is the object chosen must be a best relative fit not a perfect fit i.e. allow the maximum surface area to be consumed within the shape relevant to another given shape. The best relative fit is the one which either leaves no space or at best the minimum space not filled in, in any given object.

It is to be appreciated that the features of the many different embodiments described above, whilst being described separately, can be combined in many different ways to result in new valid embodiments.

Having described many different specific embodiments of the present invention, it is to be appreciated that the present invention is not limited by these embodiments variations and modifications such as those that will be apparent to the skilled person are to be included herein in line with the spirit and scope of the invention as defined in the appended claims.

1. A high-security gaming system for implementing a real-time instant-win game, the system comprising:
a game card arranged to facilitate game card player interaction to play the real-time instant-win game, the game card including:
a unique game card identifier;
a two-dimensional scene which has a missing object; and
location means for accurately specifying a player-selected location of the missing object within the scene;
a terminal arranged to receive game card information relating to the unique game card identifier and the player-selected location specified by the location means; and
an authentication server, operably coupled to the terminal by a communications network, for authenticating the game card and determining the result of the instant-win game;
wherein the terminal is arranged to communicate the game card information to the authentication server via the telecommunications network and the authentication server is arranged to receive and use the game card information to:
authenticate the validity of the game card by use of an authentication process on the received game card identifier;
carry out a comparison of the player-selected location with a predetermined correct location of the missing object for that game card; and
send a win message to the terminal to indicate an instant win if the player selected location is within a predetermined distance of the correct location of the missing object.

2. The system of claim 1, wherein the system comprises a plurality of game cards, each game card having a different scene printed on it.

3. The system of claim 1, wherein the terminal comprises a scanner for reading the game card information.

4. The system of claim 3, wherein the scanner comprises a mobile device including a camera.

5. The system of claim 3, wherein the scanner is also arranged to receive scanned information regarding a non-game document having a unique non-game identifier, and the terminal is arranged to generate a composite unique identifier based on a function of the game card information and the non-game identifier, which can be used as a single representation of the non-game document and the game card.

6. The system of claim 3, wherein one or more reference shapes are provided on the game card that provide spaced-apart registration points for the scene, the reference shapes are positioned according to a predetermined relative relationship such that the shapes are readily recognisable by the scanner and distinguished from the scene.

7. The system of claim 1, wherein the terminal comprises a low-cost laser for ablating a portion to the game card with encoded information.

8. The system of claim 1, wherein the terminal comprises a mobile device having access to a low-cost communications channel with the authentication server.

9. The system of any of claims 1 to 8, wherein the game card comprises a scratch-off coating with the scene printed thereon.

10. The system of claim 9, wherein the location means comprises a grid of sub-regions of the scene each provided with a unique machine-readable location identifier, each location identifier being machine readable once the scratch-off coating has been removed at a corresponding sub-region.

11. The system of claim 10, wherein a subset of the unique machine-readable location identifiers are graphically different to the identifiers not in the subset, the subset collectively defining a symbol or character which underlies the scratch-off coating and is revealed when the entire scratch-off coating is removed.

12. The system of claim 10 as dependent from claim 3, wherein the scanner is used to scan the unused scratch-off coating of the game card and the terminal is arranged to confirm that the game card does not have any significant defects which would prevent it from being used in its intended manner.

13. The system of claim 1, wherein the location means comprises a pair of graduated axes provided adjacent two transverse edges of the scene.

14. The system of claim 1, wherein the game card information comprises two player-positioned crosshairs located transversely to each other in the scene, and the terminal is arranged to use the positions of the crosshairs to determine the player-defined location of the missing object.

15. The system of claim 14, wherein the two player-manipulated crosshairs do not intersect in the scene, and the terminal is arranged to extrapolate the crosshairs to determine a position at which they could intersect, the extrapolated position being used as the player-defined location of the missing object.

16. The system of claim 1, wherein the game card information comprises a player-determined shape and a player-determined line extending from the shape to the player-defined location of the missing object.

17. The system of claim 1, wherein the terminal comprises a game card printer for printing out the game card on-demand.

18. The system of claim 17, wherein the printer is arranged to print the game card on low-cost thermographic paper.

19. The system of claim 1, wherein the terminal further comprises a set-up screen and is arranged to present on the set-up screen a plurality of scenes to the player for player selection, a scene manipulator for removing an object from each the scene prior to presentation on the set-up screen and for manipulating each selected scene to alter digitally angle of view of the scene, and the terminal is arranged to use the manipulated scene as the scene for the game card.

20. The system of claim 1, wherein the scene comprises a plurality of sub-scenes representing a sequence of events in which the missing object is changing location, and the location means is arranged to enable accurate specifying of a player-selected location of the missing object within each of the respective sub-scenes.

21. The system of claim 19, wherein the scene comprises a plurality of sub-scenes representing a sequence of events in which the missing object is changing location, and the location means is arranged to enable accurate specifying of a player-selected location of the missing object within each of the respective sub-scenes.

22. The system claim 21, wherein the terminal is arranged to present on the set-up screen a plurality of sequences of scenes to the player for player selection, and the scene manipulator is arranged to remove an object from each scene of each sequence before presentation on the set-up screen and to manipulate each selected sequence of scenes to alter digitally angle of view of the sequence of scenes, and the terminal is arranged to use the manipulated sequence of scenes as the sub-scenes on the game card.

23. The system of claim 20, wherein the terminal is arranged to determine a path through the sub-scenes reflecting a player-specified movement path of the missing object through the sub-scenes.

24. The system of claim 20, wherein the plurality of sub-scenes provided on the game card overlap.

25. The system of claim 20, wherein the plurality of sub-scenes provided on the game card are adjacent each other.

26. The system of any of claims 1 to 25, wherein the terminal comprises a display screen for presenting the game card as a virtual game card, and the locating means comprises a graphical item presented on the screen which is manipulable via player interaction with the terminal to determine the missing object location.

27. The system of claim 26, wherein the graphical item comprises two crosshairs located transversely to each other, the crossing point of the crosshairs determining the missing object location.

28. The system of claim 26, wherein the graphical item comprises at least one a magnified region, for magnifying the scene about the location of the graphical item.

29. The system of claim 26, wherein the graphical item comprises a graphical representation of the missing object which is provided outside a perimeter of the scene and which can be moved into the player-selected location of the missing object by the location means.

30. The system of claim 26 as dependent on claim 23, wherein the location means is arranged to map out a path between the locations of the missing object in the plurality of sub-scenes.

31. The system of claim 26 as dependent on claim 19, wherein the set-up screen of the terminal is the display screen.

32. The system of any of claims 1 to 25, further comprising an authentication database operably connected to the authentication server for storing the locations of the missing objects.

33. The system of claim 32, wherein the terminal comprises a display screen for presenting the game card as a virtual game card, and the locating means comprises a graphical item presented on the screen which is manipulable via player interaction with the terminal to determine the missing object location, the system further comprising a device database operably connected to the authentication server for storing device data describing the screen dimensions and resolutions of a plurality of different devices which can act as terminals, wherein the terminal is arranged to provide terminal identification information with the game card information, and the authentication server is arranged to use the device data to translate a received player-selected location of a missing object from a particular device into a device-independent domain for comparison with the locations of the missing objects in the authentication database.

34. The system of claim 1, wherein the terminal is arranged to present to the player a unique transaction identifier provided in the win message received from the authentication server.

35. The system of claim 34, further comprising a prize-dispensing device arranged to receive the unique transaction identifier, send the transaction identifier to the authentication server and dispense the prize on receiving from the authentication server a signal authenticating the transaction identifier.

36. The system of claim 35, wherein the terminal and the prize-dispensing device together comprise an automated teller machine (ATM).

37. The system of any of claims 1 to 18, wherein the game card is included within the functionality of an account top-up card having a unique access code that needs to be communicated to a facilities server to facilitate the top-up services of the card, the game card being configured to enable the communication of the player-selected location to the facilities server as an adage to the access code.

38. A high-security game card arranged to facilitate game card player interaction to play a real-time instant-win game, the game card comprising:
a unique game card identifier;
a two-dimensional scene which has a missing object; and
location means for accurately specifying a player-selected location of the missing object within the scene.

39. The game card of claim 38, wherein reference shapes are provided on the game card that provide spaced apart registration points for the scene, the reference shapes are positioned according to a predetermined relative relationship such that the shapes can be readily recognisable by a scanner and distinguished from the scene.

40. The game card of claim 38, wherein the game card comprises a scratch-off coating with the scene printed thereon.

41. The game card of claim 40, wherein the location means comprises a grid of sub-regions of the scene each provided with a unique machine-readable location identifier, each location identifier being machine readable once the scratch-off coating has been removed at a corresponding sub-region.

42. The game card of claim 41, wherein a subset of the unique machine-readable location identifiers are graphically different to the identifiers not in the subset, the subset collectively defining a symbol or character which underlies the scratch-off coating and is revealed when the entire scratch-off coating is removed.

43. A game card of any of claims 38 to 42, wherein the game card is included within the functionality of an account top-up card having a unique access code that needs to be communicated to a server to facilitate the services of the card, the game card being configured to enable the communication of the player-selected location to the server as an adage to the access code.

44. A method of recording a missing object location within a scene of a virtual gaming card, the method comprising:
displaying the scene having a blocked region and a white-space region on the display of a device;
providing two player-manipulable crosshairs located transversely to each other, which can be extended into the white-space region of the scene;
enabling adjustment of the positions of the crosshairs on the scene to define the missing object location at the crossing point of the crosshairs; and
recording the missing object location.

45. A method of recording a missing object location within a scene of a gaming card, the method comprising:
receiving a scene having a blocked region and a white-space region on the display of a device;
determining an outline of an item within the scene;
creating a coded identifier for the game card which specifies the location of the outline;
block filling in a region defined by the outline; and
creating a game card with the scene having the blocked-filled region of the scene in place of the item; thereby reducing the potential area of the scene which is available for player selected location marks to be recorded and presenting information to a scene reading device of which areas in the scene to ignore.

46. A method of recording a missing object location within a scene of a gaming card, the method comprising:
receiving a scene having a blocked region and a white-space region on the display of a device;
determining an outline of an item within the scene;
creating a coded identifier for the game card which specifies the location of the outline;
filling in a region defined by the outline with white-space;
creating a game card with the scene having the outline and white space-filled region of the scene in place of the item; thereby reducing the potential area of the scene which is available for player-selected location marks to be recorded and by virtue of the coded identifier presenting information to a scene-reading device of regions of the scene where a maximum number of potential player-selected marks can be present.

47. A method according to claim 46, further comprising applying rules for the location of the player-selected location of the missing object location

48. A method according to any of claims 45 to 47, further comprising
providing two player-manipulable crosshairs located transversely to each other, which can be extended into the white-space region of the scene;
enabling adjustment of the positions of the crosshairs on the scene to define the missing object location at the crossing point of the crosshairs; and
recording the missing object location.
